(19) United States
(12) Patent Application Publication
(10) Pub. No.: US 2024/0065335 A1
(43) Pub. Date: Feb. 29, 2024

(54) CIRCUIT UNIT FOR AEROSOL GENERATION DEVICE, AND AEROSOL GENERATION DEVICE

(71) Applicant: Japan Tobacco Inc., Tokyo (JP)

(72) Inventors: Tatsunari AOYAMA, Tokyo (JP); Hiroshi KAWANAGO, Tokyo (JP); Toru NAGAHAMA, Tokyo (JP); Takashi FUJIKI, Tokyo (JP); Ryo YOSHIDA, Tokyo (JP)

(73) Assignee: Japan Tobacco Inc., Tokyo (JP)

(21) Appl. No.: 18/502,048

(22) Filed: Nov. 5, 2023

Related U.S. Application Data
(63) Continuation of application No. PCT/JP2022/005334, filed on Feb. 10, 2022.

(30) Foreign Application Priority Data
May 10, 2021 (JP) 2021-080020

(51) Int. Cl. A24F 40/53; H02J 7/00

(52) U.S. Cl. CPC A24F 40/53; H02J 7/00034; H02J 7/0048; A24F 40/95

(57) ABSTRACT

A circuit for an aerosol generation device includes: a heater connector to which is connected a heater that consumes power supplied from a power supply and heats an aerosol source; a controller that includes a first communication terminal and a second communication terminal for serial communication, and controls supply of power from the power supply to the heater; a first IC that is a separate entity from the controller and that includes a third communication terminal for serial communication; a second IC that is a separate entity from the controller and the first IC, and that includes a fourth communication terminal for serial communication; a first communication line that connects the first communication terminal and the third communication terminal; and a second communication line that connects the second communication terminal and the fourth communication terminal and that does not have an electrical contact with the first communication line.

### CROSS-REFERENCE TO RELATED APPLICATIONS

This is a continuation of International Application No. PCT/JP2022/005334 filed on Feb. 10, 2022, and claims priority from Japanese Patent Application No. 2021-080020 filed on May 10, 2021, the entire content of each is incorporated herein by reference.

### TECHNICAL FIELD

The present disclosure relates to a circuit unit for an aerosol generation device, and an aerosol generation device.

### CITATION LIST

### Patent Literature

PTL 1: Japanese Unexamined Patent Application Publication (Translation of PCT Application) No. 2019-526889

PTL 2: Japanese Unexamined Patent Application Publication (Translation of PCT Application) No. 2019-511909

PTL 3: US Patent Application Publication No. 2020/0000146

### SUMMARY OF INVENTION

### Technical Problem

An object of the present disclosure is to provide an aerosol generation device and a circuit unit for the aerosol generation device attaining a communication speed that does not decrease even when the number of mounted ICs is increased.

### Solution to Problem

A first feature is a circuit unit for an aerosol generation device, the circuit unit including: a heater connector to which a heater that heats an aerosol source by consuming electric power supplied from a power supply is connected; a controller that includes a first communication terminal and a second communication terminal for serial communication and that controls supply of the electric power from the power supply to the heater; a first IC that is separate from the controller and that includes a third communication terminal for serial communication; a second IC that is separate from the controller and the first IC and that includes a fourth communication terminal for serial communication; a first communication line that connects the first communication terminal and the third communication terminal; and a second communication line that connects the second communication terminal and the fourth communication terminal and that does not have an electrical contact with the first communication line.

A second feature is the circuit unit according to the first feature, in which the controller receives data from the first IC at a timing that overlaps a timing when the controller receives data from the second IC or a timing when the controller transmits data to the second IC, and/or the controller receives data from the second IC at a timing that overlaps a timing when the controller receives data from the first IC or a timing when the controller transmits data to the first IC.

A third feature is the circuit unit according to the first feature, in which the controller operates in any one of a plurality of modes, and any one of modes, among the plurality of modes, in which the controller communicates with the first IC is the same as any one of modes, among the plurality of modes, in which the controller communicates with the second IC.

A fourth feature is the circuit unit according to any one of the first to third features, in which the controller periodically communicates with the second IC.

A fifth feature is the circuit unit according to any one of the first to fourth features, in which the number of modes, among a plurality of modes, in which the controller communicates with the second IC is larger than the number of modes, among the plurality of modes, in which the controller does not communicate with the second IC.

A sixth feature is the circuit unit according to the fifth feature, in which the plurality of modes include a sleep mode in which a transition to any other mode is allowed, the sleep mode being a mode in which power consumption is smaller than in any other mode, and the controller communicates with the second IC through the second communication line in all modes among the plurality of modes except the sleep mode.

A seventh feature is the circuit unit according to the fifth feature, in which the plurality of modes include a sleep mode in which a transition to any other mode is allowed and an error mode in which charging of the power supply is at least temporarily prohibited, the sleep mode being a mode in which power consumption is smaller than in any other mode, and the controller communicates with the second IC through the second communication line in all modes among the plurality of modes except the sleep mode and the error mode.

An eighth feature is the circuit unit according to the fifth feature, in which the controller communicates with the second IC in all modes included in the plurality of modes.

A ninth feature is the circuit unit according to any one of the first to eighth features, further including: a third IC that is separate from all of the controller, the first IC, and the second IC and that includes a fifth communication terminal for serial communication, in which the first communication line connects the first communication terminal and the fifth communication terminal.

A tenth feature is the circuit unit according to the ninth feature, in which the controller communicates with the first IC in response to satisfaction of a first condition, and communicates with the third IC in response to satisfaction of a second condition different from the first condition.

An eleventh feature is the circuit unit according to the ninth feature, in which the controller is configured to operate in any one of a plurality of modes, and the plurality of modes include a mode in which the controller communicates only with the third IC among the first IC and the third IC.

A twelfth feature is the circuit unit according to any one of the first to eleventh features, in which the number of ICs connected to the controller via the first communication line is larger than the number of ICs connected to the controller via the second communication line.

A thirteenth feature is the circuit unit according to the twelfth feature, in which the second IC is a sole IC connected to the controller via the second communication line.

A fourteenth feature is the circuit unit according to the thirteenth feature, in which the second IC is a remaining charge meter IC that obtains information about the power supply.

A fifteenth feature is the circuit unit according to any one of the first to fourteenth features, in which the controller operates in any one of a plurality of modes, and the plurality of modes include a mode in which the controller does not communicate with the first IC through the first communication line and does not communicate with the second IC through the second communication line.

A sixteenth feature is the circuit unit according to any one of the first to fifteenth features, in which the first communication line and the second communication line employ I2C as a communication protocol.

A seventeenth feature is an aerosol generation device including: a heater connector to which a heater that heats an aerosol source by consuming electric power supplied from a power supply is connected; a controller that includes a first communication terminal and a second communication terminal for serial communication and that controls supply of the electric power from the power supply to the heater; a first IC that is separate from the controller and that includes a third communication terminal for serial communication; a second IC that is separate from the controller and the first IC and that includes a fourth communication terminal for serial communication; a first communication line that connects the first communication terminal and the third communication terminal; and a second communication line that connects the second communication terminal and the fourth communication terminal and that does not have an electrical contact with the first communication line.

### Advantageous Effects of Invention

### BRIEF DESCRIPTION OF DRAWINGS

FIG. 1A is a view of an aerosol generation device when its front side is viewed from diagonally above.

FIG. 1B is a view of the aerosol generation device when its front side is viewed from diagonally below.

FIG. 1C is a view of the top surface of the aerosol generation device with a shutter removed.

FIG. 1D is a view of a main-unit housing with an outer panel removed when viewed from the front.

FIG. 2A is a diagram for explaining a configuration example of the interior of an outer case that is visible when an inner panel is removed.

FIG. 2B is a diagram for explaining an external appearance example of a circuit unit included in the outer case.

FIG. 3A is a diagram for explaining a configuration example of an MCU substrate on its front surface employed in Embodiment 1.

FIG. 3B is a diagram for explaining a configuration example of the MCU substrate on its back surface employed in Embodiment 1.

FIG. 4 is a diagram for explaining circuit elements disposed on a power supply line and voltages appearing between the circuit elements.

FIG. 5 is a diagram for explaining an internal configuration example of a charging IC employed in Embodiment 1.

FIG. 6A is a diagram for explaining an electric-power supply path in the charging IC that operates in a charging mode.

FIG. 6B is a diagram for explaining an electric-power supply path in the charging IC that operates in a power supply mode with a BUS voltage V_{USB}.

FIG. 6C is a diagram for explaining electric-power supply paths in the charging IC that operates in a power supply mode with the BUS voltage V_{USB} and a battery voltage V_{BAT}.

FIG. 6D is a diagram for explaining an electric-power supply path in the charging IC that operates in a power supply mode with the battery voltage V_{BAT}.

FIG. 6E is a diagram for explaining an electric-power supply path in the charging IC that operates in a power supply mode with the OTG function for the battery voltage V_{BAT}.

FIG. 7A is a diagram for explaining a configuration example of a USB connector substrate on its front surface employed in Embodiment 1.

FIG. 7B is a diagram for explaining a configuration example of the USB connector substrate on its back surface employed in Embodiment 1.

FIG. 8 is a diagram for explaining the functions of a remaining charge meter IC.

FIG. 9 is a diagram for explaining a configuration example of a LED and a Bluetooth substrate and a Hall IC substrate employed in Embodiment 1.

FIG. 10 is a diagram for explaining communication protocol examples employed in the circuit unit.

FIG. 11 is a diagram for explaining a picture of I2C communication.

FIG. 12 is a diagram for explaining operation modes provided in the aerosol generation device employed in Embodiment 1 and conditions for transitions between the operation modes.

FIG. 13 is a table for explaining the details of communication on an operation-mode-by-operation-mode basis in Embodiment 1.

FIG. 14 is a diagram for explaining communication during a charging mode M1.

FIG. 15 is a table for explaining the details of communication on an operation-mode-by-operation-mode basis in Embodiment 2.

FIG. 16 is a table for explaining the details of communication on an operation-mode-by-operation-mode basis in Embodiment 3.

FIG. 17 is a diagram for explaining a connection form of SPI communication, which is one form of serial communication.

FIG. 18 is a diagram for explaining an external appearance configuration example of an aerosol generation device that corresponds to an electronic cigarette.

### DESCRIPTION OF EMBODIMENTS

Hereinafter, embodiments of the present disclosure will be described with reference to the drawings. The same parts illustrated in the drawings are assigned the same reference signs.

### Embodiment 1

### External Appearance Configuration Example of Aerosol Generation Device

First, an external appearance configuration example of an aerosol generation device 1 employed in Embodiment 1 will be described. The aerosol generation device 1 employed in Embodiment 1 is one form of a heated tobacco.

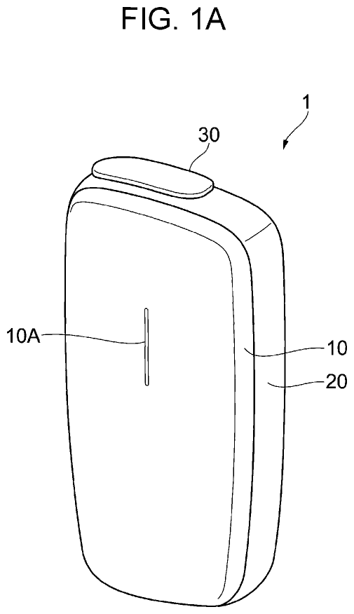

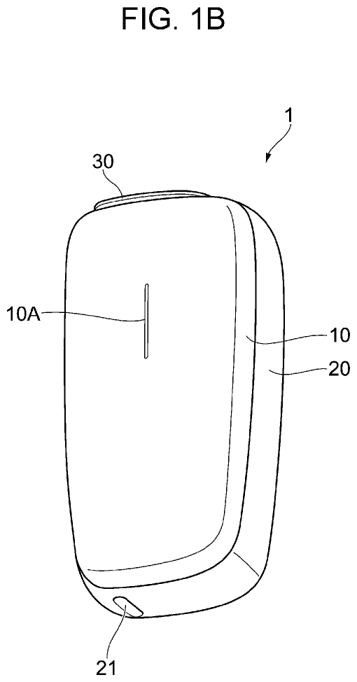

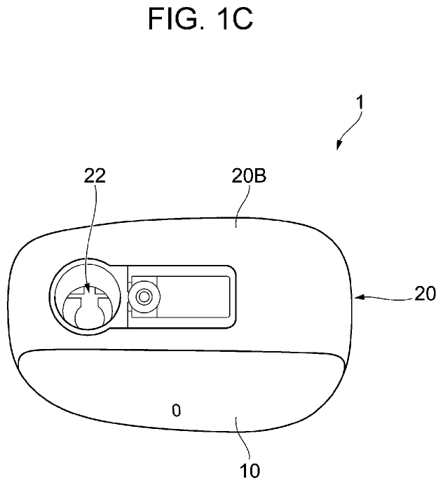

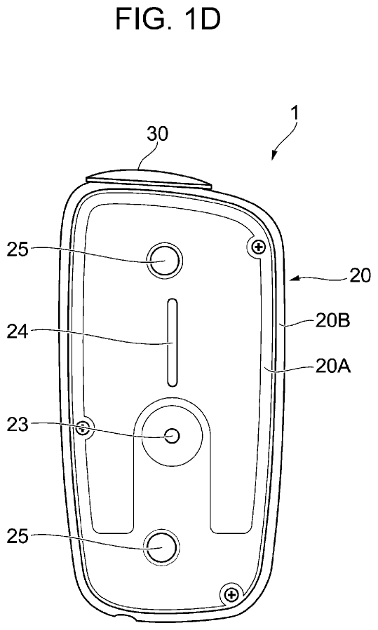

FIG. 1A is a view of the aerosol generation device 1 when its front side is viewed from diagonally above.

FIG. 1B is a view of the aerosol generation device 1 when its front side is viewed from diagonally below.

FIG. 1C is a view of the top surface of the aerosol generation device 1 with a shutter 30 removed.

FIG. 1D is a view of a main-unit housing 20 with an outer panel 10 removed when viewed from the front.

The aerosol generation device 1 employed in Embodiment 1 has a size such that the user can hold the aerosol generation device 1 in one hand.

The aerosol generation device 1 includes the main-unit housing 20, the outer panel 10 fitted to the front side of the main-unit housing 20, and the shutter 30 that is disposed on the top surface of the main-unit housing 20 and is slidable along the top surface.

The outer panel 10 is a member that is detachable from the main-unit housing 20. The outer panel 10 in Embodiment 1 is detached and reattached by the user.

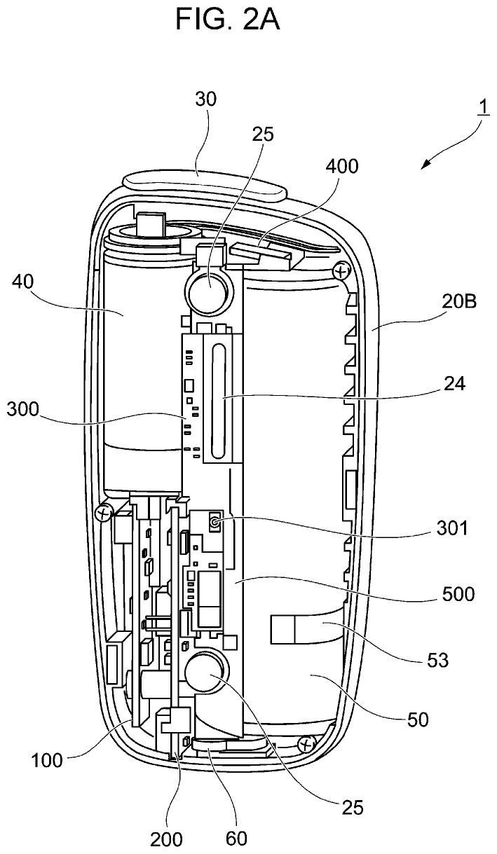

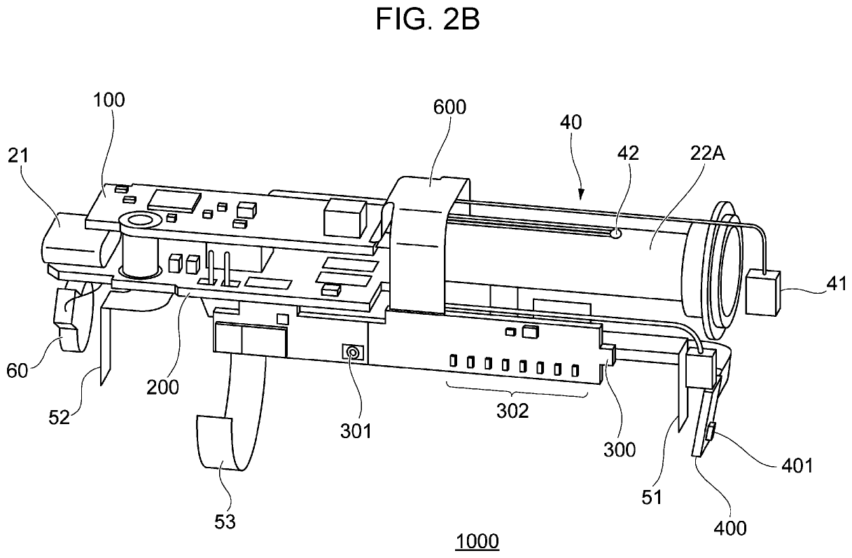

The outer panel 10 is provided with an information window 10A. The information window 10A is provided at a position so as to face light-emitting elements provided in the main-unit housing 20. As the light-emitting elements, LEDs (Light-Emitting Diodes) 302 (see FIG. 2B) are used in Embodiment 1.

The information window 10A in Embodiment 1 is formed of a light transmissive material. The information window 10A may be a hole extending from the front surface to the back surface. The light-emitting elements that illuminate and blink indicate the state of the aerosol generation device 1. Illuminating and blinking of the light-emitting elements may be controlled by an MCU 101 described below.

The outer panel 10 functions as a decoration and also has a function of absorbing heat radiated from the main-unit housing 20.

The outer panel 10 is deformed when the user presses the outer panel 10 with their fingertip at a position below the information window 10A. When the outer panel 10 is pressed with their fingertip and dented, a push button 23 provided in the main-unit housing 20 can be pressed.

On the bottom surface of the main-unit housing 20, a Type-C USB (Universal Serial Bus) connector 21 is provided. The shape and type of the USB connector 21 is an example. In other words, the USB connector 21 may be of a USB type other than Type-C. In Embodiment 1, the USB connector 21 is exclusively used to charge a battery 50 (see FIG. 2A) included in the main-unit housing 20.

On the top surface of the main-unit housing 20, an insertion hole 22 into which a stick formed of a paper tube and an aerosol source inside the paper tube is inserted is provided. The stick has an external appearance that is in a substantially columnar form wrapped in the paper tube. The insertion hole 22 is exposed when the shutter 30 is opened and is hidden when the shutter 30 is closed.

In Embodiment 1, the opening of the insertion hole 22 has a substantially round shape. The opening has a diameter so as to allow the substantially columnar stick to be inserted therethrough. In other words, the stick has a diameter so as to be insertable into the insertion hole 22.

Inside the shutter 30, a magnet is attached. Opening and closing of the shutter 30 are detected by a Hall IC 401 (see FIG. 2B) provided in the main-unit housing 20.

The Hall IC 401 is also called a magnetic sensor and is formed of a Hall element, an operational amplifier, and so on. The Hall element is an element that outputs a voltage corresponding to the strength of the magnetic field of the magnet.

The main-unit housing 20 is formed of an inner panel 20A and an outer case 20B. In Embodiment 1, the inner panel 20A is screwed to the outer case 20B.

Approximately in the center of the inner panel 20A, the push button 23 is disposed. As described above, the push button 23 is operated in response to deformation of the outer panel 10. In response to the operation of the push button 23, a tactile switch 301 (see FIG. 2B) in the outer case 20B located behind the push button 23 is operated.

The push button 23 is used to, for example, turn on or off the power of the device main unit, heat a heater, perform Bluetooth pairing, and so on. In response to holding-down of the push button 23 (for example, pressed for 5 seconds or more) with the outer panel 10 removed, a reset function is activated. In Embodiment 1, as the Bluetooth, BLE (Bluetooth Low Energy) is employed.

The tactile switch 301 may be exposed approximately in the center of the inner panel 20A to thereby omit the push button 23. In this case, deformation of the outer panel 10 directly reaches the tactile switch 301.

On the inner panel 20A, a translucent component 24 that transmits light is exposed at a position corresponding to the information window 10A of the outer panel 10. The translucent component 24 is disposed at a position so as to cover the surface of the LEDs 302.

In an upper part and a lower part of the inner panel 20A, magnets 25 used to fit the outer panel 10 are provided. The magnets 25 are provided at positions so as to face magnets on the outer panel 10. With these magnets, the outer panel 10 is fitted to the inner panel 20A so as to be detachable.

In Embodiment 1, the magnets 25 are fixed to a chassis 500 (see FIG. 2A) in the outer case 20B and are exposed from openings of the inner panel 20A. Unlike in Embodiment 1, the magnets 25 may be fixed to the inner panel 20A.

### Internal Configuration Example of Aerosol Generation Device

FIG. 2A is a diagram for explaining a configuration example of the interior of the outer case 20B that is visible when the inner panel 20A (see FIG. 1D) is removed.

FIG. 2B is a diagram for explaining an external appearance example of a circuit unit 1000 included in the outer case 20B. In Embodiment 1, a part obtained by removing the battery 50, the chassis 500, and a heater of a heating unit 40 from the outer case 20B is referred to as the circuit unit 1000.

In the outer case 20B in Embodiment 1, the heating unit 40, the battery 50, an MCU (Micro Control Unit) substrate 100, a USB connector substrate 200, an LED and Bluetooth (registered trademark) substrate 300, a Hall IC substrate 400, a vibrator 60, and the chassis 500 to which these members are fitted are provided. That is, in the outer case 20B, four separate substrates are provided. The four substrates are spaced apart from each other.

The heating unit 40 is a unit that heats a tobacco stick inserted into the insertion hole 22 (see FIG. 1C). The insertion hole 22 is defined as a space surrounded by the inner wall of a cylindrical container 22A.

The container 22A employed in Embodiment 1 has a bottom. However, the container 22A having no bottom may be employed.

The container 22A employed in Embodiment 1 has a flat part on its side wall. In other words, when the container 22A is cut along a plane orthogonal to the axial line of the container 22A, the cross section has a flat part.

The flat part compresses and deforms the side surface of a tobacco stick inserted through the opening of the insertion hole 22 (see FIG. 1C) to increase heating efficiency. Note that the cross section may have a substantially round shape, a substantially elliptic shape, or a substantially polygonal shape. Although the shape of the cross section may be unchanged in the entire part between the opening and the bottom surface, the shape may be changed in some part between the opening and the bottom surface.

The container 22A is preferably formed of metal having high heat conductivity. In Embodiment 1, the container 22A is formed of, for example, stainless steel.

Around the outer circumference of the container 22A, a film-type heater that covers the outer circumference surface is disposed. The heater produces heat by consuming electric power supplied from the battery 50. When the heater produces heat, the stick is heated from its outer circumference, and an aerosol is generated.

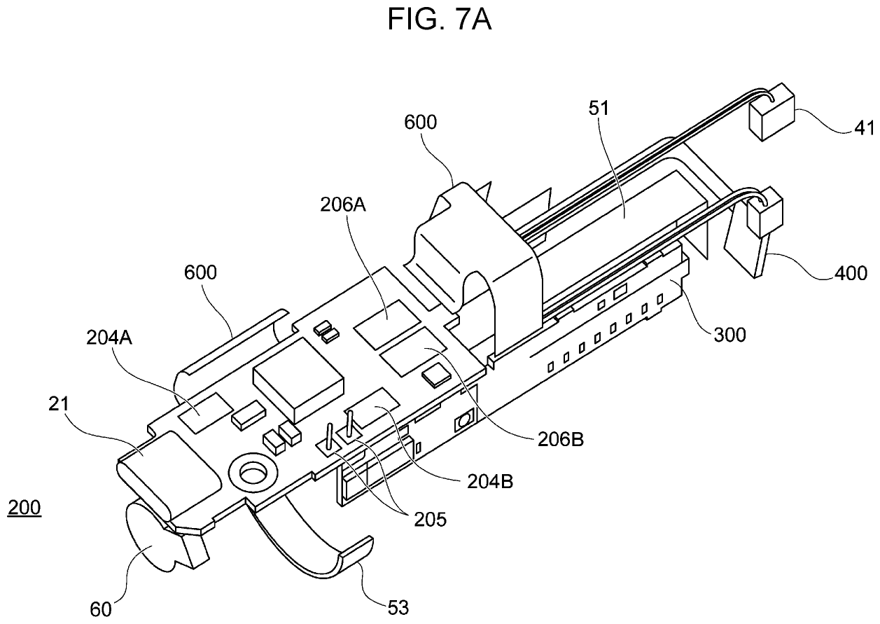

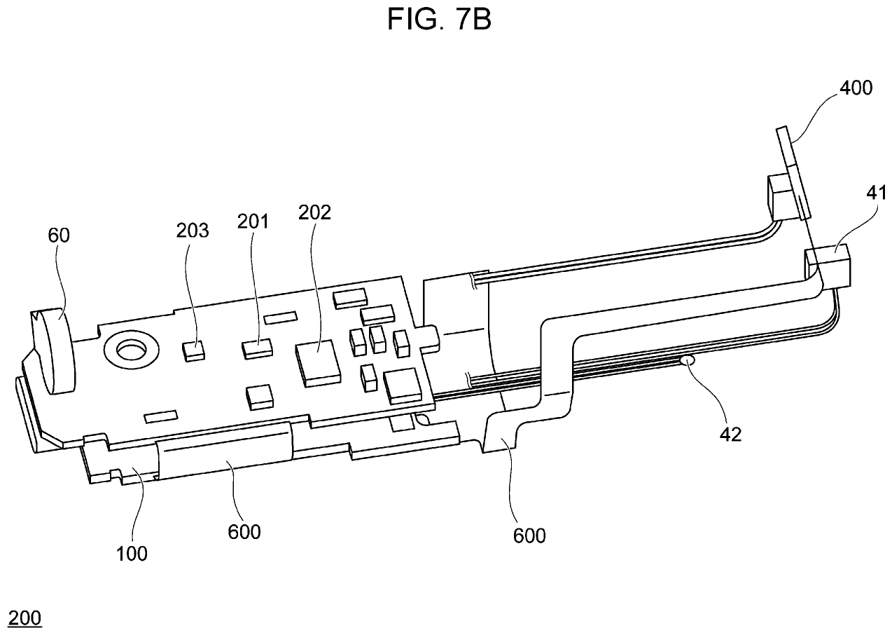

The heating unit 40 is connected to heater connectors 206A and 206B (see FIG. 7A) provided on the USB connector substrate 200 and is supplied with electric power. The heating unit 40 is also provided with a thermistor 41 used to detect puffing (that is, inhalation) and a thermistor 42 used to measure the temperature of the heater. The resistances of the thermistor 41 and the thermistor 42 change to a large degree in response to a temperature rise associated with heat production by the heater and a temperature drop associated with puffing.

As the thermistor 41, a PTC (Positive Temperature Coefficient) thermistor whose resistance increases in response to a temperature rise or an NTC (Negative Temperature Coefficient) thermistor whose resistance decreases in response to a temperature drop may be used. Similarly, as the thermistor 42, a PTC thermistor may be used or an NTC thermistor may be used.

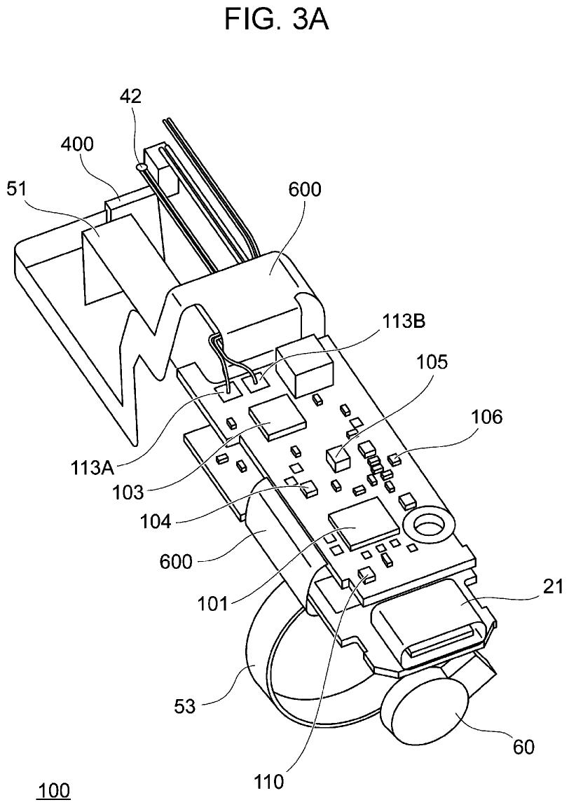

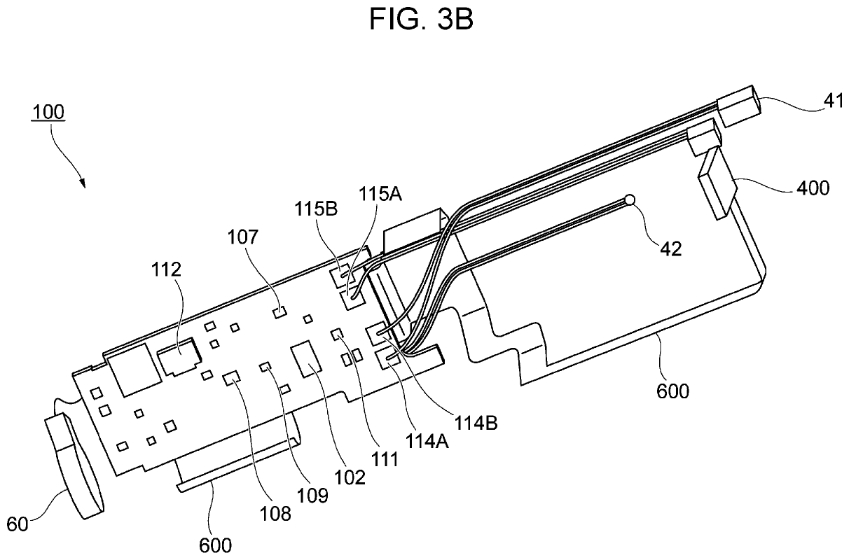

Changes in the resistances of the thermistor 41 and the thermistor 42 are detected by the MCU 101 (see FIG. 3A) as voltage changes.

In addition, the MCU 101 measures the temperature of the outer case 20B with a separate thermistor.

The battery 50 is a power supply that supplies electric power necessary for operations of the circuit unit included in the outer case 20B. In Embodiment 1, as the battery 50, for example, a rechargeable lithium-ion secondary battery is used. Electric power of the battery 50 is supplied to each part through power supply lines connected to a negative electrode 51 and a positive electrode 52.

Around the outer circumference of the battery 50, a thermistor 53 used to measure the temperature of the battery 50 (hereinafter referred to as “battery temperature”) is provided. A change in the resistance of the thermistor 53 is detected by a remaining charge meter IC 201 (see FIG. 7B) of the USB connector substrate 200 as a voltage change. As the thermistor 53, a PTC thermistor may be used or an NTC thermistor may be used.

### Configuration of MCU Substrate 100

FIG. 3A is a diagram for explaining a configuration example of the MCU substrate 100 on its front surface employed in Embodiment 1.

FIG. 3B is a diagram for explaining a configuration example of the MCU substrate 100 on its back surface employed in Embodiment 1.

The front surface and the back surface in FIG. 3A and FIG. 3B are referenced only in the description of Embodiment 1.

The MCU substrate 100 is a both-surface mount substrate.

On the MCU substrate 100, the MCU 101 that controls operations of the entire device, an EEPROM 102 that records information about use of the device and so on, and a charging IC 103 that switches an electric-power supply path are mounted.

The MCU 101 is a controller. Operations of the MCU 101 are defined by firmware or a program running on the firmware being executed.

The MCU 101 in Embodiment 1 communicates with other ICs through I2C communication or UART communication, which are serial communication methods. In Embodiment 1, two lines are provided as communication lines for I2C communication.

A first line is a communication line used by the MCU 101 in I2C communication with the EEPROM 102 and with the charging IC 103 mounted on the same substrate (that is, the MCU substrate 100) on which the MCU 101 is mounted.

A second line is a communication line used by the MCU 101 in I2C communication with the remaining charge meter IC 201 mounted on a separate substrate (that is, the USB connector substrate 200) adjacent to the MCU substrate 100.

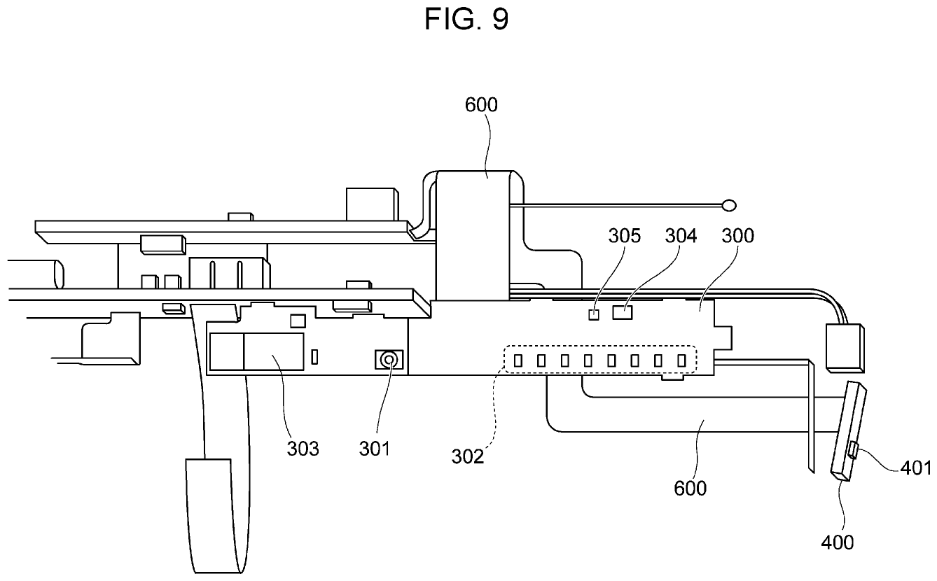

The first line and the second line do not have an electrical contact. Accordingly, communication through the first line and communication through the second line are independent of each other. The MCU 101 communicates with a Bluetooth IC 303 (see FIG. 9) mounted on the LED and Bluetooth substrate 300 that is located farther from the MCU substrate 100 than the USB connector substrate 200 is, through UART communication.

The charging IC 103 is provided with a BAT terminal that receives power of the battery voltage V_{BAT} supplied from the battery 50 and a VBUS terminal that receives power of the BUS voltage V_{USB} supplied from an external power supply.

In the aerosol generation device 1 in Embodiment 1, a power supply line used to supply the battery voltage V_{BAT} is separated into two power supply lines. The charging IC 103 is connected to one of the power supply lines. The other power supply line is connected to the remaining charge meter IC 201 and to a step-up DC/DC circuit 202 (see FIG. 7B) that generates a voltage to be applied to the heater. In addition, the battery voltage V_{BAT} is also connected to a protection IC 203 (see FIG. 7B) of the battery 50.

On the MCU substrate 100, a load switch 104 that turns on or off the power supply line connecting the external power supply and the charging IC 103 is mounted. The external power supply is an external device that is connected via the USB connector 21. Examples of the external device include a personal computer, a smartphone, a tablet terminal, and an outlet.

On the MCU substrate 100, a step-up/step-down DC/DC circuit 105 that generates a system power V_{cc33_0} of 3.3 V from a voltage V_{cc} output from the charging IC 103 is mounted. The step-up/step-down DC/DC circuit 105 may increase the voltage V_{cc} output from the charging IC 103 to generate the system power V_{cc33_0}, decrease the voltage V_{cc} output from the charging IC 103 to generate the system power V_{cc33_0}, or output the voltage V_{cc} output from the charging IC 103 as is to generate the system power V_{cc33_0}.

The step-up/step-down DC/DC circuit 105 increases the voltage when the battery voltage V_{BAT} is lower than 3.3 V, decreases the voltage when the battery voltage V_{BAT} is higher than 3.3 V, or outputs the voltage as is when the battery voltage V_{BAT} is equal to 3.3 V.

The system power V_{cc33_0} here is primitive power continuously supplied even when the MCU 101 is not operating.

The system power V_{cc33_0} is supplied to a power switch driver 108, a load switch 106 for a system stop, and a flip-flop 107 that latches (saves) a value indicating whether the heater is in an overheat state, through power supply lines. In other words, these circuit elements operate even when the system is not operating.

When the load switch 106 for a system stop is turned off, only a circuit element to which the system power V_{cc33_0} is supplied operates. As a result, almost all circuit elements including the MCU 101 stop operating.

On the MCU substrate 100, the power switch driver 108 is mounted. The power switch driver 108 is a circuit for controlling the load switch 106 to be ON or OFF.

In response to detection of the push button 23 (see FIG. 1D) pressed with the outer panel 10 removed, the power switch driver 108 controls the load switch 106 to be OFF.

Removal of the outer panel 10 is detected by a Hall IC 304 (see FIG. 9) used to detect the outer panel 10 attached to or detached from the main-unit housing 20 and by a single Schmitt trigger inverter 305 (see FIG. 9) that receives the output potential of the Hall IC 304.

The MCU 101 is not involved in control of the load switch 106 by the power switch driver 108. That is, the load switch 106 is controlled independently of the MCU 101.

In this embodiment, a system power of 3.3 V supplied to each part from the load switch 106 in an ON state is expressed by V_{cc33} and is distinguished from the system power V_{cc33_0} continuously supplied even when the system is not operating.

On the MCU substrate 100, a load switch 109 that supplies a system power V_{cc33_SLP} to the three thermistors described above when the shutter 30 is in an open state is mounted.

Therefore, when the shutter 30 is in a close state, the system power V_{cc33_SLP} is not supplied to the three thermistors. To the load switch 109, the system power V_{cc33} of 3.3 V is supplied from the load switch 106 for a system stop.

On the MCU substrate 100, a flip-flop 110 that latches a value indicating whether the temperature of the outer case 20B is abnormal is mounted. To the flip-flop 110, the system power V_{cc33} is supplied from the load switch 106 for a system stop.

On the MCU substrate 100, an operational amplifier 111 used to measure the heater resistance (heater temperature) is mounted.

On the MCU substrate 100, a connector 112 for the vibrator 60 is mounted.

On the MCU substrate 100, connectors 113A and 113B for the thermistor 42 that measures the heater temperature are mounted. The connector 113A is for a positive electrode, and the connector 113B is for a negative electrode. Note that wiring lines that connect the thermistor 41 with connectors 113A and 113B are omitted in FIG. 3B.

On the MCU substrate 100, the connectors 114A and 114B for the thermistor 41 used to detect puffing (that is, inhalation) are mounted. The connector 114A is for a positive electrode, and the connector 114B is for a negative electrode.

On the MCU substrate 100, connectors 115A and 115B for the thermistor used to detect the temperature of the outer case 20B are mounted. The connector 115A is for a positive electrode, and the connector 115B is for a negative electrode.

For the MCU substrate 100, a flexible substrate 600 on which wiring patterns used to communicate with circuit elements mounted on substrates other than the MCU substrate 100 are formed is used. The flexible substrate 600 also includes power supply patterns.

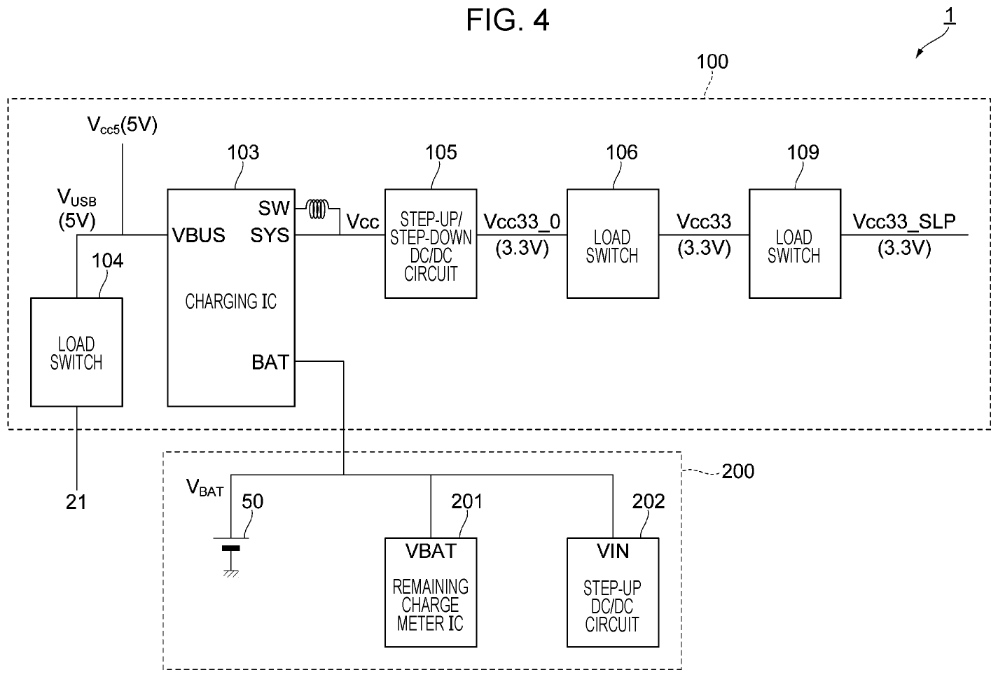

FIG. 4 is a diagram for explaining circuit elements disposed on a power supply line and voltages appearing between the circuit elements.

In the aerosol generation device 1 in Embodiment 1, the power supply line of the battery 50 is separated into two lines. One of the two lines is connected to the BAT terminal of the charging IC 103, and the other line is connected to the VBAT terminal of the remaining charge meter IC 201 and the VIN terminal of the step-up DC/DC circuit 202. The power supply line is separated into two lines, and therefore, a large current supplied to the heater does not pass through the charging IC 103. Accordingly, the charging IC 103 need not be enlarged.

The remaining charge meter IC 201 operates in response to supply of the system power V_{cc33} and monitors, for example, the battery voltage V_{BAT} supplied to the BAT terminal.

The step-up DC/DC circuit 202 increases the battery voltage V_{BAT} to generate a boost voltage V_{boost} that is applied to the heater. The electric power is supplied to the heater in response to ON control of a MOSFET (not illustrated) connected to the output terminal of the step-up DC/DC circuit 202.

The remaining charge meter IC 201 and the step-up DC/DC circuit 202 are mounted on the USB connector substrate 200.

The charging IC 103 generates the voltage V_{cc} from the battery voltage V_{BAT} supplied from the battery 50 and the BUS voltage V_{USB} supplied from the external power supply and supplies the voltage Vcc to the step-up/step-down DC/DC circuit 105.

The step-up/step-down DC/DC circuit 105 generates the system power V_{cc33_0} of 3.3 V from the voltage V_{cc} and supplies the system power V_{cc33_0} to the load switch 106 and so on. The system power V_{cc33_0} is continuously supplied even when the system is not operating (even when the MCU 101 is not operating).

The load switch 106 supplies the system power V_{cc33} of 3.3 V to the MCU 101, the load switch 109, and so on only to operate the MCU 101 (see FIG. 3A) and so on. The system power V_{cc33} is supplied also to the remaining charge meter IC 201.

The load switch 109 outputs the system power V_{cc33_SLP} of 3.3 V to a power supply line only when three thermistors measure temperatures. The three thermistors refer to the thermistor 41 used to detect puffing, the thermistor 42 used to measure the temperature of the heater, and the thermistor used to measure the temperature of the outer case 20B.

The charging IC 103 supplies power of 5 V generated from the battery voltage V_{BAT} to the LEDs 302 (see FIG. 2B) as V_{cc5}. To the LEDs 302, the BUS voltage V_{USB} may be supplied.

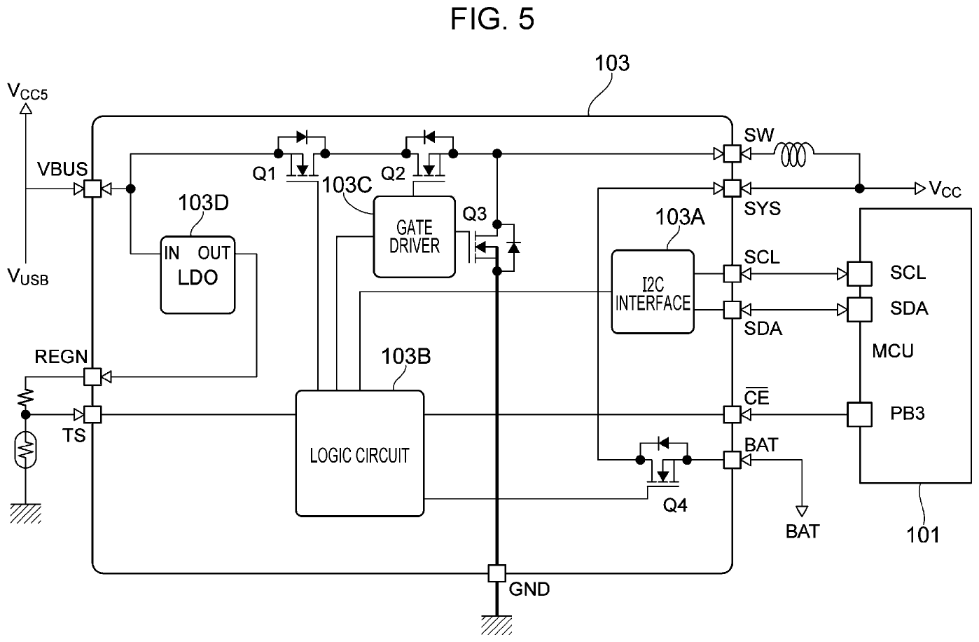

FIG. 5 is a diagram for explaining an internal configuration example of the charging IC 103 employed in Embodiment 1.

The charging IC 103 illustrated in FIG. 5 is provided with an I2C interface 103A, a logic circuit 103B, a gate driver 103C, a low-dropout regulator (hereinafter referred to as “LDO”) 103D, and four MOSFETs Q1 to Q4.

The I2C interface 103A is used in I2C communication with the MCU 101 that is on the same substrate.

To the BAT terminal of the charging IC 103, the battery 50 is connected via the power supply line. Accordingly, the battery voltage V_{BAT} is supplied to the BAT terminal of the charging IC 103 except during charging.

To the VBUS terminal of the charging IC 103, the USB connector 21 is connected via the load switch 104 (see FIG. 4). The load switch 104 is controlled to be in an ON state only when reception of the BUS voltage V_{USB} that is the external power is detected, and is controlled to be in an OFF state when reception of the BUS voltage V_{USB} is not detected. The MCU 101 may switch between the ON state and the OFF state of the load switch 104.

The charging IC 103 handles five types of power supply modes.

The five types of power supply modes include a charging mode, a power supply mode with the BUS voltage V_{USB}, a power supply mode with both the BUS voltage V_{USB} and the battery voltage V_{BAT}, a power supply mode with the battery voltage V_{BAT}, and a power supply mode with the OTG (On-The-Go) function for the battery voltage V_{BAT}.

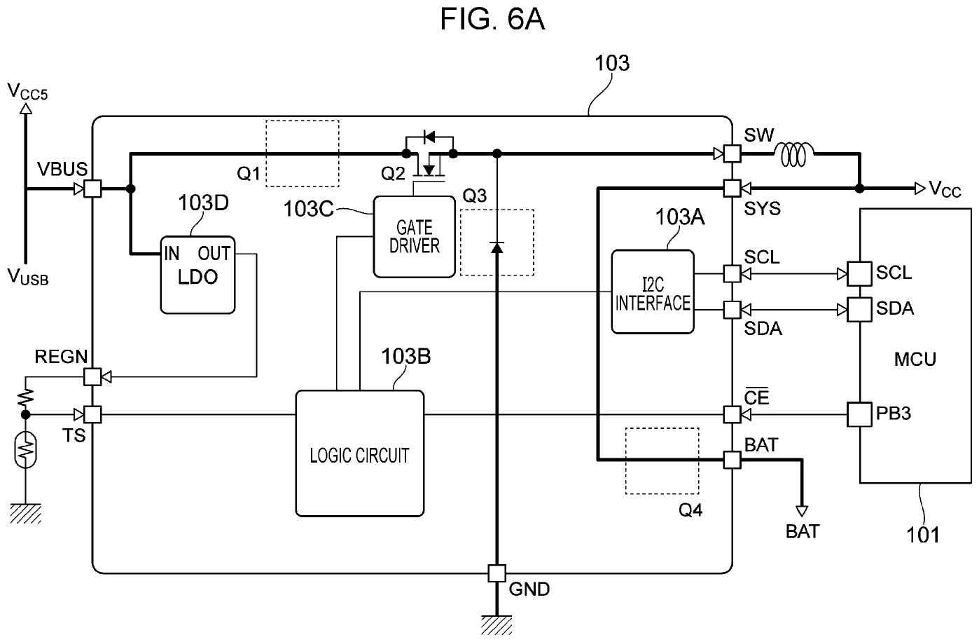

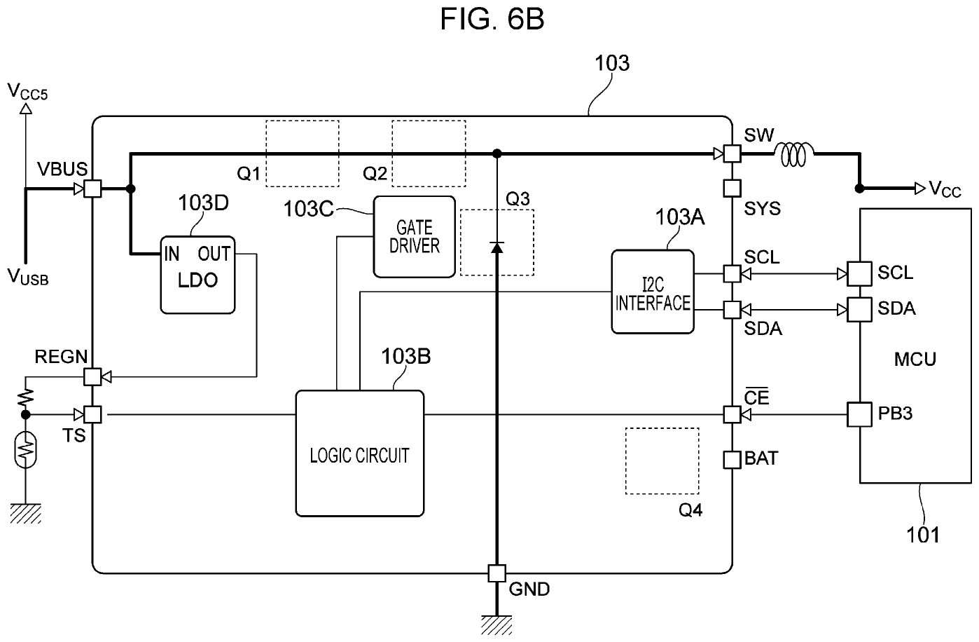

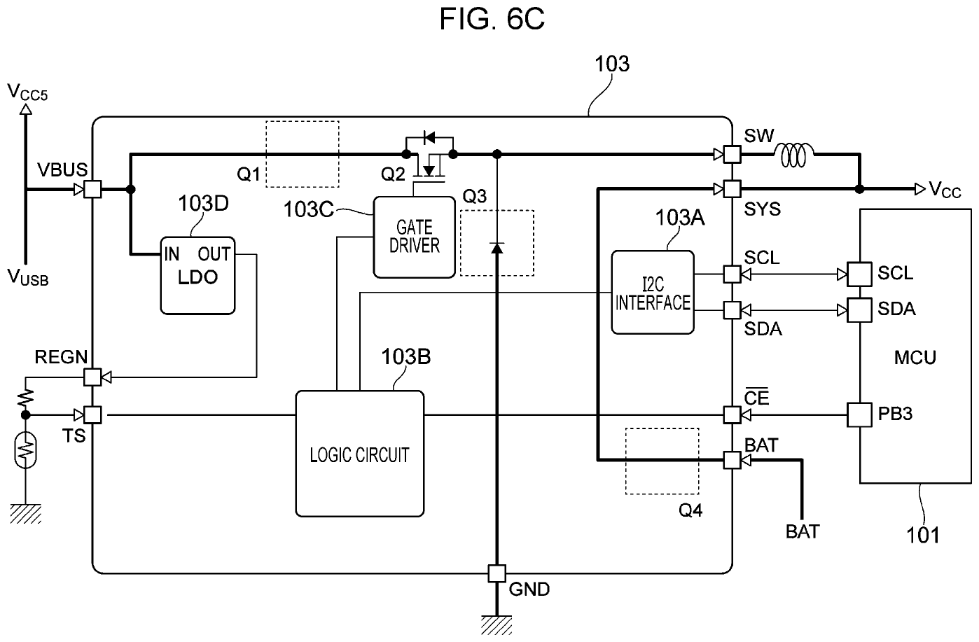

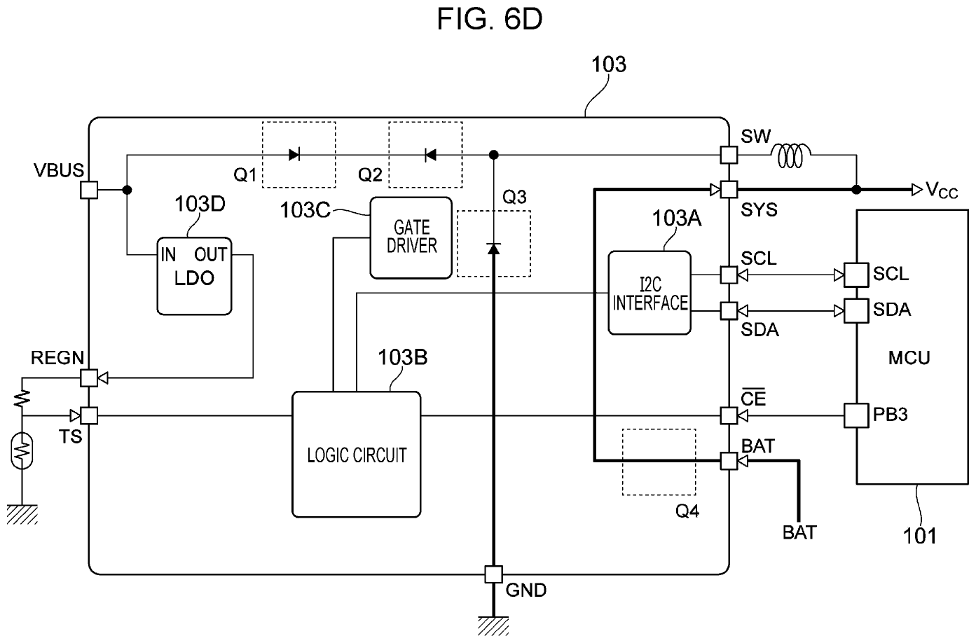

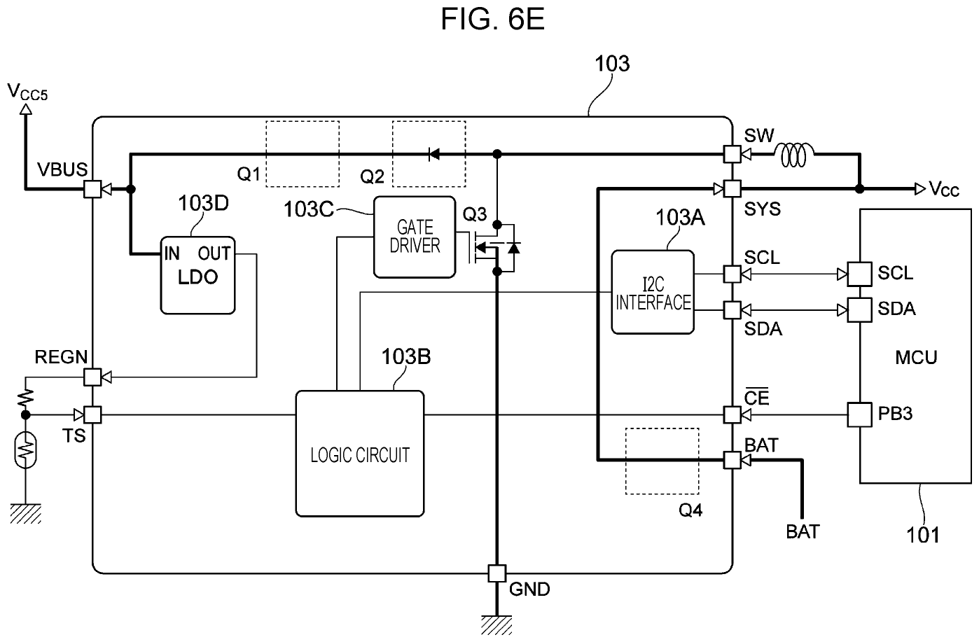

FIG. 6A is a diagram for explaining an electric-power supply path in the charging IC 103 that operates in the charging mode.

The charging mode is executed in response to application of a low-level signal to the CE terminal from the MCU 101 in a state in which a USB cable is connected to the USB connector 21 (see FIG. 1B).

In the charging mode, the FETs Q1 and Q4 are controlled to be ON, the FET Q3 is controlled to be OFF, and the FET Q2 is PWM (Pulse Width Modulation)-controlled. When the FETs Q1 to Q4 are thus controlled, the charging IC 103 operates as a step-down regulator (converter).

The BUS voltage V_{USB} applied to the VBUS terminal is a power of about 5 V.

The FET Q2 is controlled to be ON or OFF by the gate driver 103C. The gate driver 103C is switched on the basis of a charging current or a charging voltage obtained by the logic circuit 103B from a terminal or a wiring line not illustrated. When the FET Q2 is switched, the BUS voltage V_{USB} is decreased to a voltage suitable for charging of the battery 50.

The voltage V_{cc} output from the SW terminal of the charging IC 103 via an inductance is re-input to the SYS terminal, and subsequently, output to the battery 50 (see FIG. 2A) from the BAT terminal (to charge the battery 50).

FIG. 6B is a diagram for explaining a power supply path in the charging IC 103 that operates in the power supply mode with the BUS voltage V_{USB}.

This power supply mode is executed in response to application of a high-level signal to the CE terminal from the MCU 101 in a state in which a USB cable is connected to the USB connector 21 (see FIG. 1B) and an abnormality occurs in the battery 50. An abnormality of the battery 50 refers to a state in which discharging from the battery 50 is prohibited because the battery 50 is in an over-discharge state or a deep-discharge state.

In response to application of a high-level signal to the CE terminal, PWM control of the FET Q2 is stopped.

In this power supply mode, the FETs Q1 and Q2 are controlled to be ON and the FETs Q3 and Q4 are controlled to be OFF.

The FETs Q1 and Q2 are controlled to be ON and the FET Q3 is controlled to be OFF, and therefore, the system power V_{cc} appearing at the SW terminal is equal to the BUS voltage V_{USB}.

The FET Q4 is turned off, and therefore, the battery 50 is isolated from the charging IC 103.

FIG. 6C is a diagram for explaining electric-power supply paths in the charging IC 103 that operates in the power supply mode with both the BUS voltage V_{USB} and the battery voltage V_{BAT}.

This power supply mode is executed in response to application of a high-level signal to the CE terminal from the MCU 101 in a state in which a USB cable is connected to the USB connector 21 (see FIG. 1B) and no abnormality occurs in the battery 50.

In this power supply mode, the FETs Q1 and Q4 are controlled to be ON, the FET Q3 is controlled to be OFF, and the FET Q2 is PWM-controlled.

PWM control in this power supply mode is performed such that the voltage at the SYS terminal is equal to the battery voltage V_{BAT}. Accordingly, electric power derived from the BUS voltage V_{USB} and electric power derived from the battery 50 are combined and supplied to the step-up/step-down DC/DC circuit 105 (see FIG. 4).

In this power supply mode, the voltage at the SYS terminal is equal to the battery voltage V_{BAT}, and therefore, discharging from the battery 50 continues.

FIG. 6D is a diagram for explaining an electric-power supply path in the charging IC 103 that operates in the power supply mode with the battery voltage V_{BAT}.

This power supply mode is executed in response to application of a high-level signal to the CE terminal from the MCU 101 in a state in which a USB cable is not connected to the USB connector 21 (see FIG. 1B).

In this power supply mode, the FET Q4 is controlled to be ON and the FETs Q1, Q2, and Q3 are controlled to be OFF.

In this power supply mode, the voltage V_{cc} output from the SYS terminal is equal to the value of the battery voltage V_{BAT}. Therefore, when the value of the battery voltage V_{BAT} decreases to a value lower than a value at the time of full charge, the voltage V_{cc} similarly decreases.

In this power supply mode, the voltage V_{cc} at the SYS terminal fluctuates.

The line between the SW terminal and the VBUS terminal is blocked by a parasitic diode of the FET Q1. Accordingly, a voltage of 5 V caused by a reverse power flow (OTG function) of the charging IC 103 is not generated.

FIG. 6E is a diagram for explaining an electric-power supply path in the charging IC 103 that operates in the power supply mode with the OTG function for the battery voltage V_{BAT}.

This power supply mode is executed in response to application of a high-level signal to the CE terminal from the MCU 101 in a state in which the I2C interface 103A is instructed by the MCU 101 through I2C communication to use the OTG function.

In this power supply mode, the FETs Q1 and Q4 are controlled to be ON, the FET Q2 is controlled to be OFF, and the FET Q3 is PWM-controlled. When the FETs Q1 to Q4 are thus controlled, the charging IC 103 operates as a step-up regulator (converter).

In this power supply mode, the voltage V_{cc} output from the SYS terminal is also equal to the value of the battery voltage V_{BAT}. Therefore, when the value of the battery voltage V_{BAT} decreases to a value lower than a value at the time of full charge, the voltage V_{cc} similarly decreases.

In this power supply mode, while the FET Q3 is controlled to be ON, a current flows into the GND terminal via an inductance. When the FET Q3 is subsequently controlled to be OFF, a reverse voltage is generated at the inductance. With this reverse power, a voltage that is the voltage V_{cc} increased up to 5 V appears at the VBUS terminal. When a voltage of 5 V is output, the LEDs 302 (see FIG. 2B) become ready for use. For the LEDs 302 to emit light, a transistor inside the MCU 101 needs to be closed. In other words, the LEDs 302 are grounded via the transistor provided inside the MCU 101.

Although a case where the CE terminal of the charging IC 103 is based on a negative logic operation in each of the operation modes has been described above, the charging IC 103 in which the CE terminal is based on a positive logic operation may be used.

In this case, for example, to operate the charging IC 103 in the charging mode, a high-level signal needs to be applied to the CE terminal from the MCU 101.

### Configuration of USB Connector Substrate

FIG. 7A is a diagram for explaining a configuration example of the USB connector substrate 200 on its front surface employed in Embodiment 1.

FIG. 7B is a diagram for explaining a configuration example of the USB connector substrate 200 on its back surface employed in Embodiment 1.

The front surface and the back surface in FIG. 7A and FIG. 7B are referenced only in the description of Embodiment 1.

The USB connector substrate 200 is a substrate that handles a voltage higher than that handled by other substrates.

The USB connector substrate 200 is also a both-surface mount substrate.

On the USB connector substrate 200, the USB connector 21 is mounted. The USB connector 21 in this embodiment is used to receive electric power supplied from the external power supply via a USB cable.

In addition, the remaining charge meter IC 201 that collects information about the battery 50 (see FIG. 2A) and the step-up DC/DC circuit 202 are mounted on the USB connector substrate 200.

The remaining charge meter IC 201 has the VBAT terminal to which the power supply line of the battery 50 is connected. The remaining charge meter IC 201 operates in response to reception of the system power V_{cc33} of 3.3 V supplied from the load switch 106 (see FIG. 4) and obtains information about, for example, the amount of remaining charge in the battery 50 on the basis of, for example, an input to the VBAT terminal.

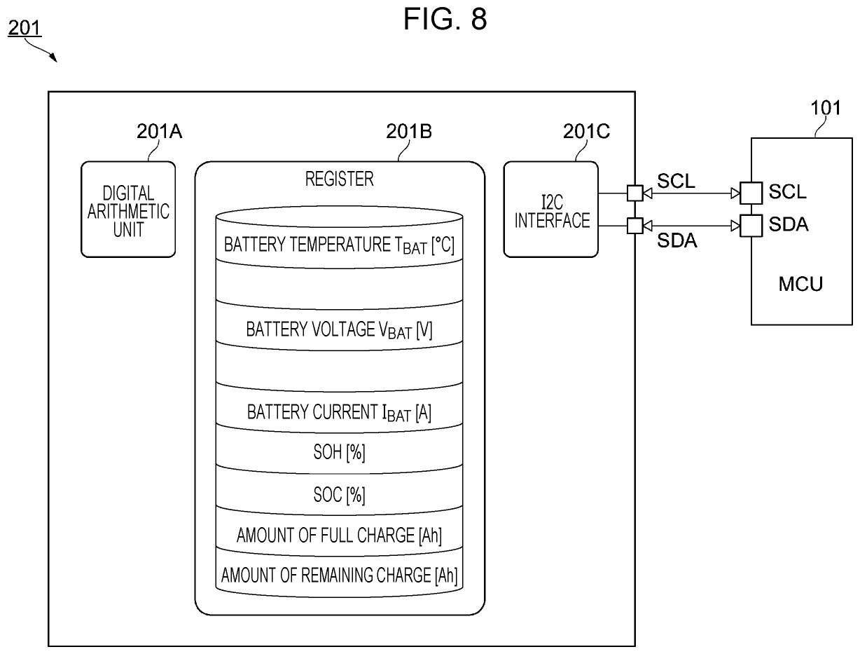

FIG. 8 is a diagram for explaining the functions of the remaining charge meter IC 201. FIG. 8 illustrates a digital arithmetic unit 201A, a register 201B, and an I2C interface 201C as representative structural elements of the remaining charge meter IC 201. Although not illustrated in FIG. 8, the remaining charge meter IC 201 has a terminal, such as the VBAT terminal, to which information about the battery 50 is input.

The digital arithmetic unit 201A calculates the amount of remaining charge (Ah) on the basis of the battery temperature T_{BAT} (° C.), the battery voltage V_{BAT} (V), and the battery current I_{BAT} (A) and stores the calculated amount of remaining charge in the register 201B. The digital arithmetic unit 201A also calculates the amount of full charge (Ah) at the present time. The battery temperature T_{BAT} (° C.) is measured by the thermistor 53 (see FIG. 2A).

The digital arithmetic unit 201A has a function of calculating the State Of Charge (SOC) when the full-charge state at the present time is assumed to correspond to 100% and the complete discharge state is assumed to correspond to 0%. The calculated SOC is also stored in the register 201B.

The digital arithmetic unit 201A also has a function of calculating the State Of Health (SOH) that is an indicator of the degree of health or the degradation state of the battery 50. The calculated SOH is also stored in the register 201B. The SOH may be expressed as the ratio of the amount of full charge at the present time to the amount of full charge in a brand-new state. The SOH in a brand-new state corresponds to 100%. Instead of using the amount of full charge, the ratio of the internal resistance of the battery 50 at the present time to the internal resistance of the battery 50 in a brand-new state may be used as the SOH.

The I2C interface 201C is used in serial communication with the MCU 101 mounted on the adjacent MCU substrate 100.

Referring back to FIG. 7A and FIG. 7B, a description will be further given.

On the USB connector substrate 200, the protection IC 203 for the battery 50 is also mounted. The protection IC 203 monitors over-charging and over-discharging of the battery 50 and an overcurrent during charging and discharging, and in response to detection of these, protects the battery 50.

On the USB connector substrate 200, connectors 204A and 204B respectively connected to the positive electrode 52 and the negative electrode 51 (see FIG. 2B) used to take electric power from the battery 50 are mounted. The connector 204A is for a positive electrode, and the connector 204B is for a negative electrode.

On the USB connector substrate 200, connectors 205 for the thermistor 53 used to measure the battery temperature are also mounted.

On the USB connector substrate 200, the heater connectors 206A and 206B are mounted. The heater connector 206A is for a positive electrode, and the heater connector 206B is for a negative electrode.

In addition, on the USB connector substrate 200, an overvoltage protection IC is also mounted. The overvoltage protection IC is located between the USB connector 21 (see FIG. 1B) and the load switch 104 and is used to monitor electric power supplied from the USB connector 21. The overvoltage protection IC disconnects the electrical connection between the USB connector 21 and the load switch 104 in response to detection of an overcurrent and/or an overvoltage.

### Configuration of LED and Bluetooth Substrate and Hall IC Substrate

FIG. 9 is a diagram for explaining a configuration example of the LED and Bluetooth substrate 300 and the Hall IC substrate 400 employed in Embodiment 1.

On the LED and Bluetooth substrate 300, the tactile switch 301 and the LEDs 302 are mounted. The tactile switch 301 is used as a power button. When the tactile switch 301 is held down with the outer panel 10 removed, the tactile switch 301 functions as a reset button of the MCU 101.

The number of LEDs 302 in Embodiment 1 is eight. In FIG. 9, the LEDs 302 are disposed in a line on the LED and Bluetooth substrate 300. The number of LEDs 302 and disposition of the LEDs 302 on the LED and Bluetooth substrate 300 can be changed as desired.

To the LEDs 302, the voltage V_{cc5} of 5 V is applied from the charging IC 103 (see FIG. 4) or from the USB connector 21. With the combination of the eight LEDs 302 each emitting or not emitting light, various items of information are provided to the user. For example, the amount of remaining charge in the battery 50 is indicated. For example, a notification that resetting is performed is given. Resetting is performed in response to holding-down of the push button 23 (that is, the tactile switch 301) with the outer panel 10 removed from the main-unit housing 20.

Light emission of the LEDs 302 is PWM-controlled by the MCU 101 (see FIG. 3A).

The LED and Bluetooth substrate 300 to which the voltage V_{cc5} of 5 V is applied is provided as a substrate separate from the MCU substrate 100 and the USB connector substrate 200 described above, and therefore, wiring lines and heat are not concentrated on one substrate. Light emission of the LEDs 302 may be controlled in a more sophisticated manner by using a driver.

In addition, on the LED and Bluetooth substrate 300, the Bluetooth IC 303 is mounted. The Bluetooth IC 303 performs communication with a paired external device. Pairing is performed on condition that the tactile switch 301 is pressed with the shutter 30 closed. To the Bluetooth IC 303, the system power V_{cc33} of 3.3 V is supplied.

In communication between the Bluetooth IC 303 and the MCU 101, UART communication is used.

On the LED and Bluetooth substrate 300, the Hall IC 304 used to detect attachment and detachment of the outer panel 10 to and from the main-unit housing 20 and the single Schmitt trigger inverter 305 that stabilizes an output of the Hall IC 304 by using hysteresis characteristics are mounted. To the Hall IC 304 and the single Schmitt trigger inverter 305, the system power V_{cc33} of 3.3 V is also supplied. The single Schmitt trigger inverter 305 may be omitted.

On the Hall IC substrate 400, the Hall IC 401 that detects opening and closing of the shutter 30 is mounted. To the Hall IC 401, the system power V_{cc33} of 3.3 V is also supplied. The Hall IC substrate 400 is also connected to the MCU 101 via the flexible substrate 600.

### Communication Protocols

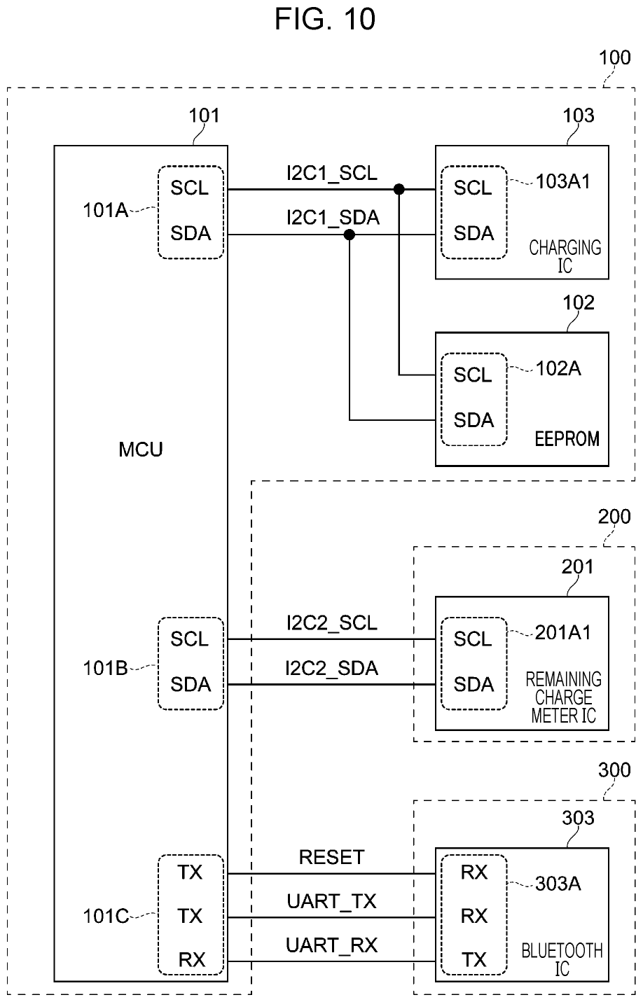

FIG. 10 is a diagram for explaining communication protocol examples employed in the circuit unit 1000 (see FIG. 2B). Specifically, FIG. 10 illustrates communication protocols used in communication by the MCU 101 with other ICs.

The MCU 101 in Embodiment 1 communicates with other ICs by using a plurality of communication protocols. Specifically, the MCU 101 uses I2C communication and UART communication.

In Embodiment 1, two communication lines correspond to I2C communication, and one communication line corresponds to UART communication.

In Embodiment 1, the two communication lines corresponding to I2C communication include a first communication line used in communication with ICs on the same substrate on which the MCU 101 is mounted and a second communication line used in communication with an IC on a substrate different from the substrate on which the MCU 101 is mounted. There is no electrical contact between the first communication line and the second communication line. That is, communication on the first communication line and communication on the second communication line are independent of each other.

One communication line that corresponds to UART communication is a third communication line.

In FIG. 10, the first communication line is denoted by “I2C1” and the second communication line is denoted by “I2C2”.

The first communication line is implemented as a wiring pattern on the MCU substrate 100. In Embodiment 1, the MCU substrate 100 is also referred to as a first substrate.

In FIG. 10, the MCU 101 is provided with a first communication terminal 101A for the first communication line and a second communication terminal 101B for the second communication line.

The MCU 101 is connected to the EEPROM 102 and to the charging IC 103 via the first communication line.

In Embodiment 1, the charging IC 103 is also referred to as a first IC, and the EEPROM 102 is also referred to as a third IC.

In FIG. 10, the charging IC 103 is provided with a third communication terminal 103A1 for the first communication line, and the EEPROM 102 is provided with a fifth communication terminal 102A for the first communication line.

The second communication line is included in the flexible substrate 600 (see FIG. 7B) that connects the MCU substrate 100 and the USB connector substrate 200.

In Embodiment 1, the MCU substrate 100 and the USB connector substrate 200 are disposed such that their substrate planes are substantially in parallel. This relationship between the substrates can be confirmed also with, for example, FIG. 2A, FIG. 2B, and FIG. 3A. In other words, the USB connector substrate 200 is located adjacent to the MCU substrate 100.

A distance on the flexible substrate 600 that connects the MCU substrate 100 and the USB connector substrate 200 is shorter than a distance on the flexible substrate 600 that connects the MCU substrate 100 and the LED and Bluetooth substrate 300. The distance on the flexible substrate 600 that connects the MCU substrate 100 and the LED and Bluetooth substrate 300 is shorter than a distance on the flexible substrate 600 that connects the MCU substrate 100 and the Hall IC substrate 400. This relationship in terms of disposition can be confirmed with, for example, FIG. 9.

In Embodiment 1, the USB connector substrate 200 is also referred to as a second substrate.

The MCU 101 is connected to the remaining charge meter IC 201 via the second communication line.

In Embodiment 1, the remaining charge meter IC 201 is also referred to as a second IC.

In FIG. 10, the remaining charge meter IC 201 is provided with a fourth communication terminal 201A1 for the second communication line.

In Embodiment 1, the LED and Bluetooth substrate 300 is also referred to as a third substrate.

The third communication line for UART communication is included in the flexible substrate 600 (see FIG. 7A) that connects the MCU substrate 100 and the LED and Bluetooth substrate 300.

The MCU 101 is connected to the Bluetooth IC 303 via the third communication line.

In Embodiment 1, the Bluetooth IC 303 is also referred to as a fourth IC.

In FIG. 10, the MCU 101 is provided with a sixth communication terminal 101C for the third communication line. The Bluetooth IC 303 is provided with a seventh communication terminal 303A for the third communication line.

I2C communication enables one-to-many communication. That is, I2C communication employs bus connections. Therefore, in I2C communication, a communication destination is specified with an address.

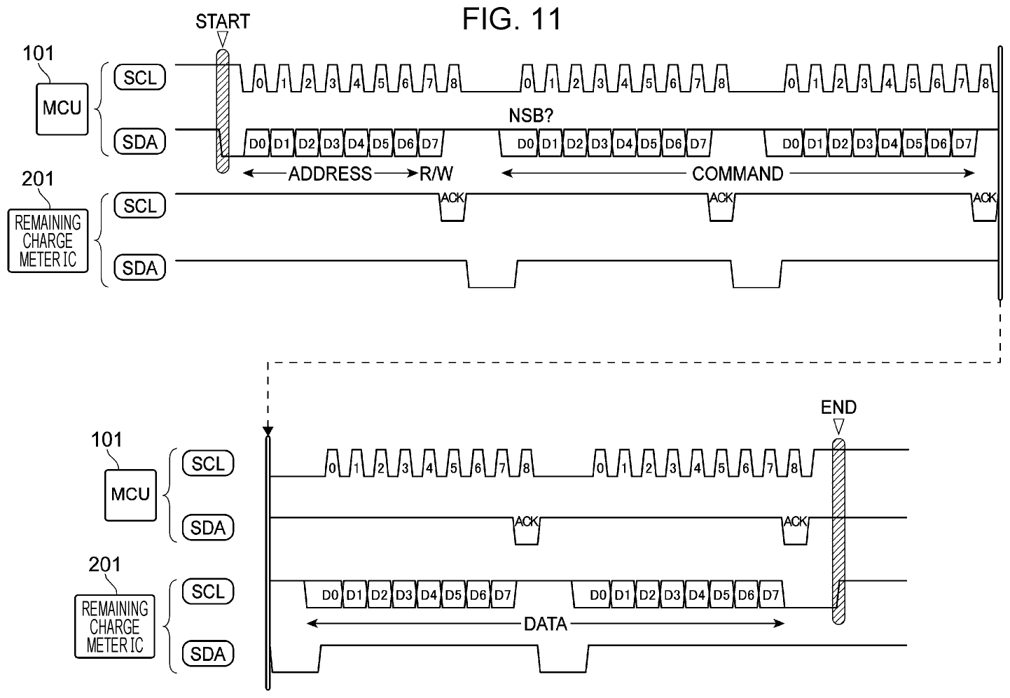

FIG. 11 is a diagram for explaining a picture of I2C communication. FIG. 11 illustrates, for example, communication between the MCU 101 and the remaining charge meter IC 201. That is, FIG. 11 illustrates a communication example using the second communication line. As illustrated in FIG. 11, in I2C communication, transmission of an address, transmission of a command, and transmission of data are performed in this order. In I2C communication illustrated in FIG. 11, although transmission of a command and transmission of data are performed in a multibyte format, the transmission may be performed in a single-byte format.

The first communication line and the second communication line corresponding to I2C communication each include two signal lines, namely, a clock line SCL for serial communication and a data line SDA for serial communication, regardless of the number of connected ICs. The rate of I2C communication is 0.1 to 1 Mbps. The clock line SCL is used to transmit and receive clock pulses for giving synchronization timings and ACKs, and the data line SDA is used to transmit and receive an address, a command, and data described above.

In contrast, UART communication provides a one-to-one connection and is asynchronous communication using no clocks.

In one-way communication, the number of signal lines for UART communication is one, and in two-way communication, the number of signal lines for UART communication is two. In the example illustrated in FIG. 10, three signal lines including a reset line are used.

The rate of UART communication is 0.1 to 115 kbps. That is, the rate of UART communication is lower than that of I2C communication.

However, UART communication enables long-distance communication. Accordingly, in Embodiment 1, UART communication is used in communication between the MCU 101 and the LED and Bluetooth substrate 300 in which the distance on the flexible substrate 600 is long.

### Operation Modes

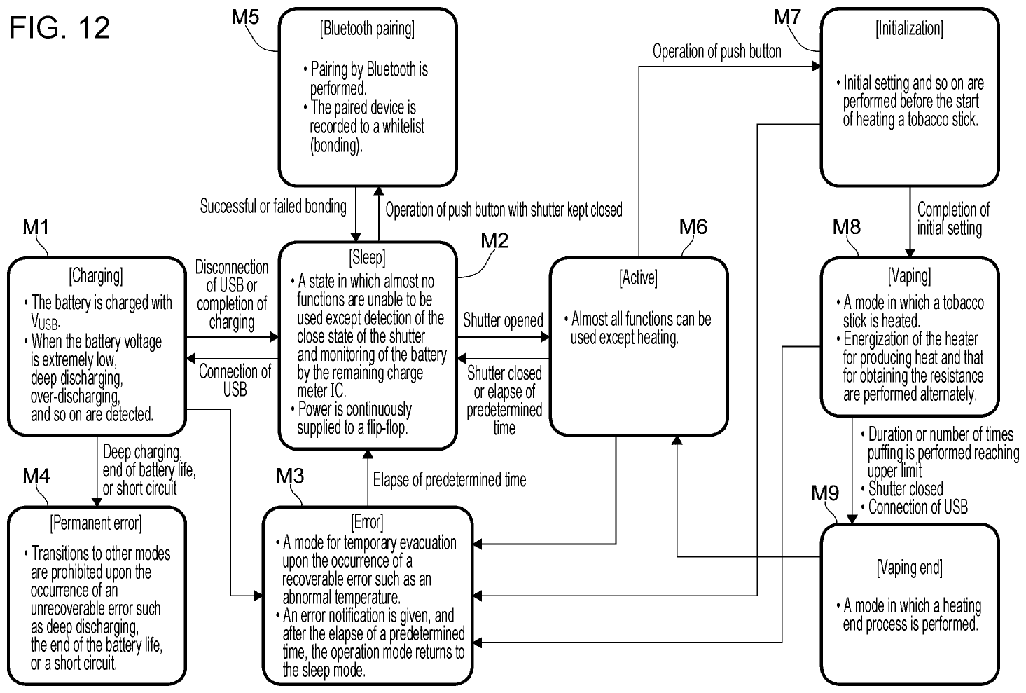

FIG. 12 is a diagram for explaining operation modes provided in the aerosol generation device 1 employed in Embodiment 1 and conditions for transitions between the operation modes. In the following description, a transition between operation modes may also be referred to as a transition mode.

The aerosol generation device 1 employed in this embodiment has nine operation modes. The nine operation modes include a charging mode M1, a sleep mode M2, an error mode M3, a permanent error mode M4, a Bluetooth pairing mode M5, an active mode M6, an initialization mode M7, a vaping mode M8, and a vaping end mode M9.

Each of the operation modes will be described below in order.

### Charging Mode M1

The charging mode M1 is a mode in which the battery 50 is charged with the BUS voltage V_{USB}.

In the charging mode M1, when the battery voltage V_{BAT} of the battery 50 (see FIG. 2A) is extremely low, deep discharging, over-discharging, and so on may be detected.

### Sleep Mode M2

The sleep mode M2 is a state in which almost no functions are unable to be used except detection of the close state of the shutter 30 (see FIG. 1A) and monitoring of the battery 50 by the remaining charge meter IC 201. Therefore, power consumption in the sleep mode M2 is smaller than in other modes.

However, the system power V_{cc33_0} is continuously supplied to a flip-flop. As a result, a value saved in the flip-flop to which power is continuously supplied is maintained.

A transition to the sleep mode M2 occurs in response to a disconnection of the USB cable or completion of charging in the charging mode M1. A transition to the charging mode M1 occurs in response to a connection of a USB cable in the sleep mode M2. In addition, the sleep mode M2 can transition to the Bluetooth pairing mode M5 and to the active mode M6. In response to a connection of a USB cable in a mode other than the sleep mode M2, a transition to the charging mode M1 may occur.

### Error Mode M3

The error mode M3 is a mode for temporary evacuation upon the occurrence of a recoverable error, such as an abnormal temperature.

After a transition to the error mode M3, an error notification is given, and after the elapse of a predetermined time or in response to satisfaction of a predetermined condition for removing the error, the operation mode returns to the sleep mode M2.

A transition to the error mode M3 occurs also from the charging mode M1, the active mode M6, the vaping initialization mode M7, and the vaping mode M8. Permanent error mode M4

The permanent error mode M4 is a mode in which transitions to other modes are prohibited upon the occurrence of an unrecoverable error, such as deep discharging, the end of the battery life, or a short circuit. FIG. 12 does not illustrate arrows extending from the permanent error mode M4 to other modes.

### Bluetooth Pairing Mode M5

The Bluetooth pairing mode M5 is a mode in which pairing with an external device by Bluetooth is performed. The paired external device is recorded to a whitelist. That is, the paired external device is bonded.

A transition to the Bluetooth pairing mode M5 occurs in response to the push button 23 (FIG. 1D) operated with the shutter 30 kept closed in the sleep mode M2.

When bonding is successfully completed or fails in the Bluetooth pairing mode M5, a transition to the sleep mode M2 occurs.

### Active Mode M6

The active mode M6 is a mode in which almost all functions can be used except heating.

A transition to the active mode M6 occurs in response to opening of the shutter 30 in the sleep mode M2. In contrast, when the shutter 30 is closed or a predetermined time has elapsed in the active mode M6, a transition to the sleep mode M2 occurs.

### Vaping Initialization Mode M7

The vaping initialization mode M7 is a mode in which initial setting and so on are performed before the start of heating a stick.

A transition to the initialization mode M7 occurs in response to the push button 23 operated in the active mode M6.

When an error occurs during initialization, the initialization mode M7 transitions to the error mode M3.

### Vaping Mode M8

The vaping mode M8 is a mode in which a tobacco stick is heated. Energization of the heater for producing heat and that for obtaining the resistance are performed alternately. The temperature profile of the heater successively changes.

A transition to the vaping mode M8 occurs in response to completion of initial setting in the initialization mode M7. When an error occurs during the vaping mode M8, a transition to the error mode M3 occurs.

### Vaping End Mode M9

The vaping end mode M9 is a mode in which a heating end process is performed.

A transition to the vaping end mode M9 occurs when the duration or the number of times puffing is performed reaches an upper limit, when the shutter 30 is closed, or when a USB is connected in the vaping mode M8. When a transition to the vaping end mode M9 occurs in response to a connection of a USB, a transition to the charging mode M1 may subsequently occur.

In response to detection of the end of heating in the vaping end mode M9, a transition to the active mode M6 occurs.

### Details of Communication on Operation-Mode-by-Operation-Mode Basis

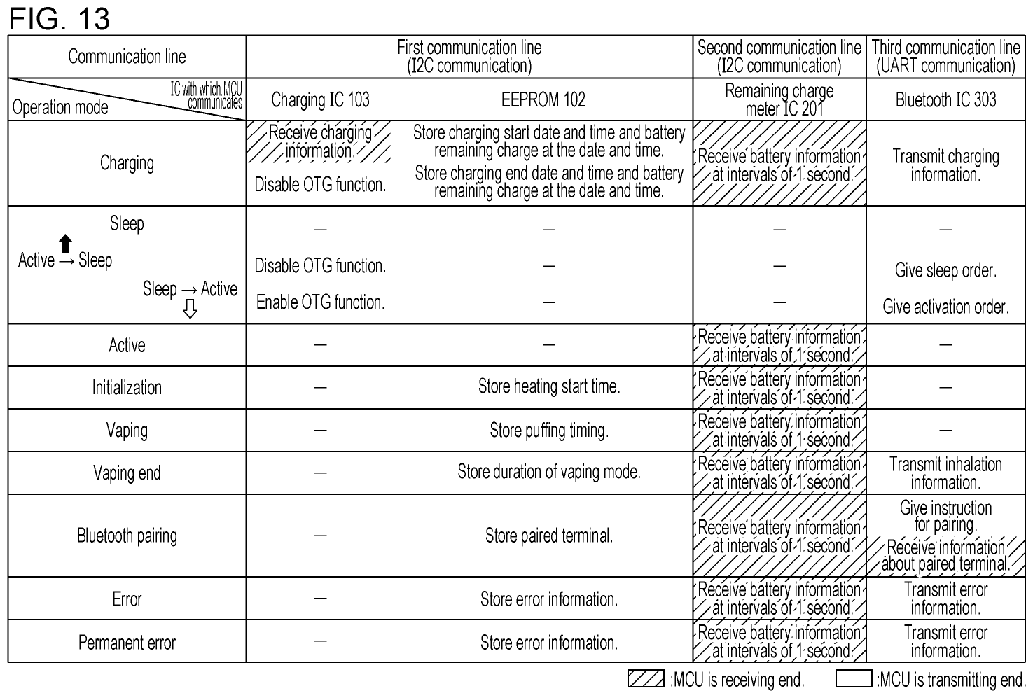

FIG. 13 is a table for explaining the details of communication on an operation-mode-by-operation-mode basis in Embodiment 1.

FIG. 13 illustrates the details of communication in the nine operation modes and two transition modes from the sleep mode, that is, eleven modes in total.

FIG. 13 illustrates communication on the three communication lines described above, that is, the first communication line and the second communication line for I2C communication and the third communication line for UART communication.

To the first communication line, the MCU 101, the EEPROM 102, and the charging IC 103 are connected.

To the second communication line, the MCU 101 and the remaining charge meter IC 201 are connected.

To the third communication line, the MCU 101 and the Bluetooth IC 303 are connected.

### Charging Mode M1

The MCU 101 receives charging information from the charging IC 103 through the first communication line. The MCU 101 transmits a command for disabling the OTG function to the charging IC 103 through the first communication line. That is, the MCU 101 instructs the charging IC 103 to disable the function of generating a voltage of 5 V from the battery voltage V_{BAT}. Accordingly, the BUS voltage V_{USB} can be supplied to the LEDs 302.

The MCU 101 transmits a command to the EEPROM 102 through the first communication line. For example, the MCU 101 transmits to the EEPROM 102 a command for storing the charging start date and time and the battery remaining charge at the date and time. For example, the MCU 101 transmits to the EEPROM 102 a command for storing the charging end date and time and the battery remaining charge at the date and time.

In this embodiment, the MCU 101 receives battery information from the remaining charge meter IC 201 through the second communication line at intervals of 1 second. The intervals of 1 second are example intervals.

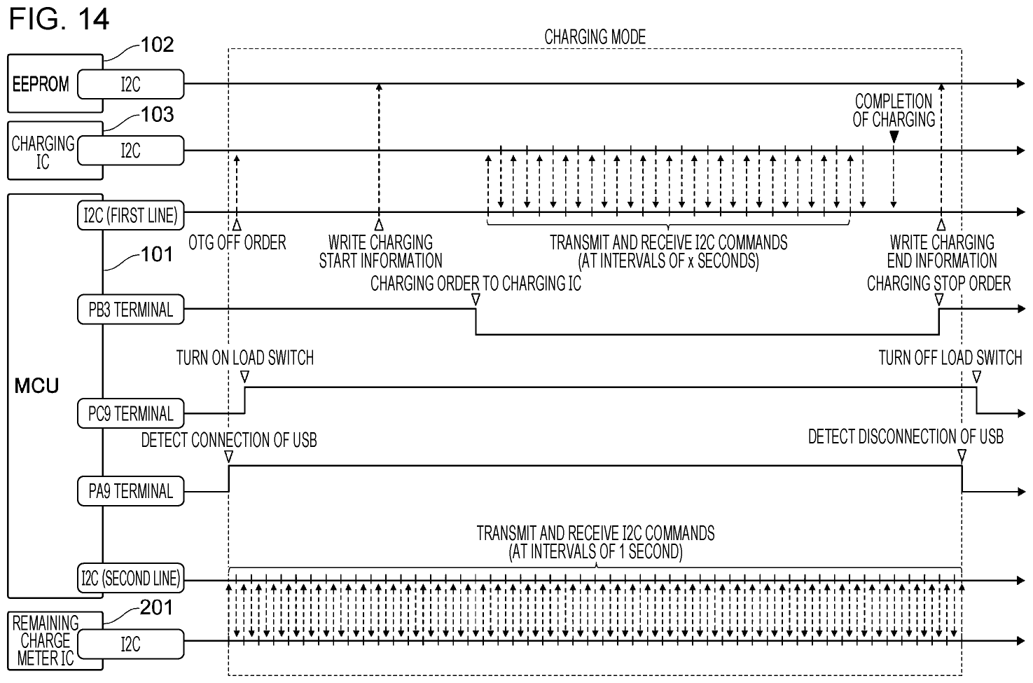

FIG. 14 is a diagram for explaining communication during the charging mode M1. Note that the initial state of the processing operation illustrated in FIG. 14 is the sleep mode M2.

When a voltage input to the PA9 terminal of the MCU 101 changes to an H level in the sleep mode M2, the MCU 101 detects a connection of a USB and changes the operation mode to the charging mode M1. To the PA9 terminal, a voltage obtained by dividing the BUS voltage V_{USB} is applied. When one end of the voltage dividing circuit is grounded, the potential at the PA9 terminal is equal to the ground potential when no USB is connected.

When the charging mode M1 starts, the MCU 101 transmits an OTG off order to the charging IC 103 on the same substrate through the first communication line (that is, the first line for I2C).

Next, the MCU 101 changes a voltage output to the PC9 terminal to the H level and controls the load switch 104 (see FIG. 4) to be ON. When the load switch 104 is put in the ON state, supply of the BUS voltage V_{USB} to the charging IC 103 starts.

The MCU 101 may set a voltage output to the PC9 terminal at an L level or an inconstant voltage to thereby control the load switch 104 to be ON. In this case, a voltage obtained by dividing the BUS voltage V_{USB} is applied to the ON terminal of the load switch 104. That is, when the voltage output to the PC9 terminal is set at the L level or an inconstant voltage, the ON terminal of the load switch 104 is at the H level with the voltage obtained by dividing the BUS voltage V_{USB}.

However, even after the start of supplying the BUS voltage V_{USB}, charging of the battery 50 by the charging IC 103 does not start. Charging of the battery 50 is started in response to the MCU 101 giving the charging IC 103 a charging order. To give this order, the first communication line is not used.

After the start of the charging mode M1, the MCU 101 transmits and receives I2C commands to and from the remaining charge meter IC 201 through the second communication line (that is, the second line for I2C) at intervals of 1 second.

This communication between the MCU 101 and the remaining charge meter IC 201 using the second communication line continues during the charging mode M1. That is, the MCU 101 can focus on communication with the remaining charge meter IC 201 without being disturbed by communication with the EEPROM 102 or the charging IC 103.

In other words, communication of the MCU 101 with the EEPROM 102 or the charging IC 103 is not disturbed by communication with the remaining charge meter IC 201.

After the load switch 104 has been controlled to be in the ON state, the MCU 101 writes charging start information to the EEPROM 102 through the first communication line. Specifically, the MCU 101 records the charging start date and time and the battery remaining charge at the date and time. At this time point, charging is not yet started.

Thereafter, the MCU 101 transmits a charging order to the charging IC 103. This charging order is given by changing the potential at the PB3 terminal of the MCU 101 to the L level. The change in the potential appearing at the PB3 terminal is transmitted to the CE terminal (see FIG. 5) of the charging IC 103.

After the start of charging in response to reception of the charging order, the MCU 101 and the charging IC 103 transmit and receive I2C commands at predetermined time intervals (for example, at intervals of x seconds).

In response to a notification of completion of charging sent from the charging IC 103 to the MCU 101, the MCU 101 instructs the EEPROM 102 to write charging end information. The MCU 101 changes the potential at the PB3 terminal to the H level to thereby transmit a charging stop order to the charging IC 103. The charging stop order for the charging IC 103 is executed by changing the potential at the PB3 terminal to the H level.

Thereafter, in response to the voltage input to the PA9 terminal changing to the L level, the MCU 101 detects a disconnection of the USB. Subsequently, the MCU 101 changes the voltage output to the PC9 terminal to the L level and controls the load switch 104 to be in the OFF state. After the load switch 104 has been controlled to be in the OFF state, supply of the BUS voltage V_{USB} to the charging IC 103 is no longer possible.

During the charging mode M1, the MCU 101 communicates with each of the EEPROM 102 and the charging IC 103 individually. That is, the timing when the MCU 101 communicates with the EEPROM 102 and the timing when the MCU 101 communicates with the charging IC 103 do not overlap. More specifically, the MCU 101 communicates with the EEPROM 102 at a timing in the initial period (before the start of charging) and at a timing in the last period (after completion of charging) in the charging mode M1. The MCU 101 communicates with the charging IC 103 at timings in the middle period (during charging) in the charging mode M1.

Communication between the MCU 101 and the EEPROM 102, communication for giving the charging IC 103 the OTG off order from the MCU 101, and communication for notifying the MCU 101 of charging completion from the charging IC 103 are performed at the time points when the respective events occur. In other words, communication on the first communication line is performed non-periodically.

In contrast, communication on the second communication line is performed periodically during the charging mode M1.

As illustrated in FIG. 14, in the charging mode M1, the timings when communication on the first communication line is performed overlap with the timings when communication on the second communication line is performed.

However, as described above, the first communication line and the second communication line are different communication lines, and therefore, communication on one of the communication lines can be performed without disturbing communication on the other communication line.

Although the second communication line is a communication line for connecting the USB connector substrate 200 different from the MCU substrate 100 on which the MCU 101 is mounted, the second communication line is for I2C communication, and therefore, enables communication at a rate higher than that in UART communication. This enables collection of information about the battery 50 at intervals of 1 second. In other words, the communication frequency on the second communication line is higher than the communication frequency on the first communication line.

It is a technical common knowledge that I2C communication employed in the second communication line is unsuitable for long-distance communication over a plurality of substrates. However, when, for example, UART communication suitable for long-distance communication is used, the frequency of communication with the remaining charge meter IC 201 decreases, and the MCU 101 may have difficulty in obtaining the latest state of the battery 50. Therefore, the USB connector substrate 200 on which the remaining charge meter IC 201 is mounted is located adjacent to the MCU substrate 100. Accordingly, highly frequent communication using I2C communication is enabled also for the remaining charge meter IC 201 mounted on a separate substrate.

Referring back to FIG. 13, a description will be further given.

In parallel to communication using the first communication line and the second communication line, the MCU 101 communicates with the LED and Bluetooth substrate 300 on which the Bluetooth IC 303 is mounted, through the third communication line.

Here, the third communication line employs as the communication protocol, UART communication allowing a long communication distance. The MCU 101 transmits charging information to the Bluetooth IC 303. This charging information can be transmitted to a paired external device.

### Sleep Mode M2

The MCU 101 does not communicate with any of the EEPROM 102, the charging IC 103, or the Bluetooth IC 303.

However, in the transition period from the active mode M6 to the sleep mode M2, the MCU 101 transmits a command for disabling the OTG function to the charging IC 103 through the first communication line. The MCU 101 gives the Bluetooth IC 303 a sleep order through the third communication line. The transition period from the active mode M6 to the sleep mode M2 is one of the two transition modes.

In the transition period from the sleep mode M2 to the active mode M6, the MCU 101 transmits a command for enabling the OTG function to the charging IC 103 through the first communication line. The MCU 101 gives the Bluetooth IC 303 an activation order through the third communication line.

This transition period is an example of a first condition for communicating only with the charging IC 103, which is the first IC. The transition period from the sleep mode M2 to the active mode M6 is the other of the two transition modes.

### Error Mode M3 and Permanent Error Mode M4

The MCU 101 stores error information in the EEPROM 102 through the first communication line.

The MCU 101 receives battery information from the remaining charge meter IC 201 through the second communication line at intervals of 1 second.

The MCU 101 transmits error information to the Bluetooth IC 303 through the third communication line.

The error mode M3 and the permanent error mode M4 are examples of a second condition for communicating with the EEPROM 102, which is the third IC.

### Bluetooth Pairing Mode M5

The MCU 101 receives information about a paired terminal from the Bluetooth IC 303 through the third communication line.

Thereafter, the MCU 101 stores information about the paired terminal in the EEPROM 102 through the first communication line.

The MCU 101 receives battery information from the remaining charge meter IC 201 through the second communication line at intervals of 1 second.

The Bluetooth pairing mode M5 is also an example of the second condition for communicating with the EEPROM 102, which is the third IC.

### Active Mode M6

The MCU 101 receives battery information from the remaining charge meter IC 201 through the second communication line at intervals of 1 second. The MCU 101 in the active mode M6 communicates only with the remaining charge meter IC 201.

### Vaping Initialization Mode M7

The MCU 101 stores a heating start time in the EEPROM 102 through the first communication line.

The MCU 101 receives battery information from the remaining charge meter IC 201 through the second communication line at intervals of 1 second.

The initialization mode M7 is also an example of the second condition for communicating with the EEPROM 102, which is the third IC.

### Vaping Mode M8

The MCU 101 stores a puffing timing in the EEPROM 102 through the first communication line. The puffing timing is detected by the thermistor 41 that is used to detect puffing.

The MCU 101 receives battery information from the remaining charge meter IC 201 through the second communication line at intervals of 1 second.

The vaping mode M8 is also an example of the second condition for communicating with the EEPROM 102, which is the third IC.

### Vaping End Mode M9

The MCU 101 stores the duration of the vaping mode in the EEPROM 102 through the first communication line. The MCU 101 may store the heating end time.

The MCU 101 receives battery information from the remaining charge meter IC 201 through the second communication line at intervals of 1 second.

The MCU 101 transmits inhalation information to the Bluetooth IC 303 through the third communication line.

The vaping end mode M9 is also an example of the second condition for communicating with the EEPROM 102, which is the third IC.

### CONCLUSION

The circuit unit 1000 of the aerosol generation device 1 employed in Embodiment 1 is provided with two communication lines for I2C communication between the MCU 101 and other ICs. Accordingly, even if the number of ICs that communicate with the MCU 101 increases, highly frequent and low-latency communication with a plurality of ICs can be implemented. As a result, the accuracy of control by the MCU 101 is increased and increased functionality is implemented.

The two communication lines include the first communication line mounted on the MCU substrate 100 and the second communication line for connecting the MCU substrate 100 and the USB connector substrate 200.

Two lines for I2C communication are provided separately for the respective substrates that are communication targets, and therefore, communication lines are not concentrated on one substrate, which prevents wiring patterns from becoming complicated or having a higher density. As a result, manufacturing costs of the aerosol generation device 1 can be reduced.

I2C communication is employed in communication with the USB connector substrate 200 adjacent to the MCU substrate 100 to thereby allow high-speed communication between the MCU 101 and the remaining charge meter IC 201. In other words, the MCU 101 can obtain the state of the battery 50 with low latency.

In contrast, UART communication is employed in communication with the LED and Bluetooth substrate 300 in which the distance of communication on the flexible substrate 600 is longer than that in communication with the USB connector substrate 200 to thereby implement communication with the Bluetooth IC 303 over a longer communication distance with more certainty.

The MCU 101 communicates with the plurality of ICs sharing the first communication line at different timings, and therefore, the accuracy of communication between the MCU 101 and each of the ICs is increased.

The charging mode M1 is a mode in which the MCU 101 communicates with both the EEPROM 102 and the charging IC 103 through the first communication line.

The sleep mode M2 is a mode in which the MCU 101 does not communicate with the EEPROM 102 or the charging IC 103 through the first communication line.

In the sleep mode M2, the transition period from the active mode M6 and the transition period to the active mode M6 are modes in which the MCU 101 communicates only with the charging IC 103 through the first communication line.

The active mode M6 is a mode in which the MCU 101 does not communicate with the EEPROM 102 or the charging IC 103 through the first communication line.

The remaining operation modes, that is, the error mode M3, the permanent error mode M4, the Bluetooth pairing mode M5, the initialization mode M7, the vaping mode M8, and the vaping end mode M9, are modes in which the MCU 101 communicates only with the EEPROM 102 through the first communication line.

### Embodiment 2

The aerosol generation device 1 (see FIG. 1A) employed in Embodiment 2 is different in that part of communication in some operation modes is different from Embodiment 1.

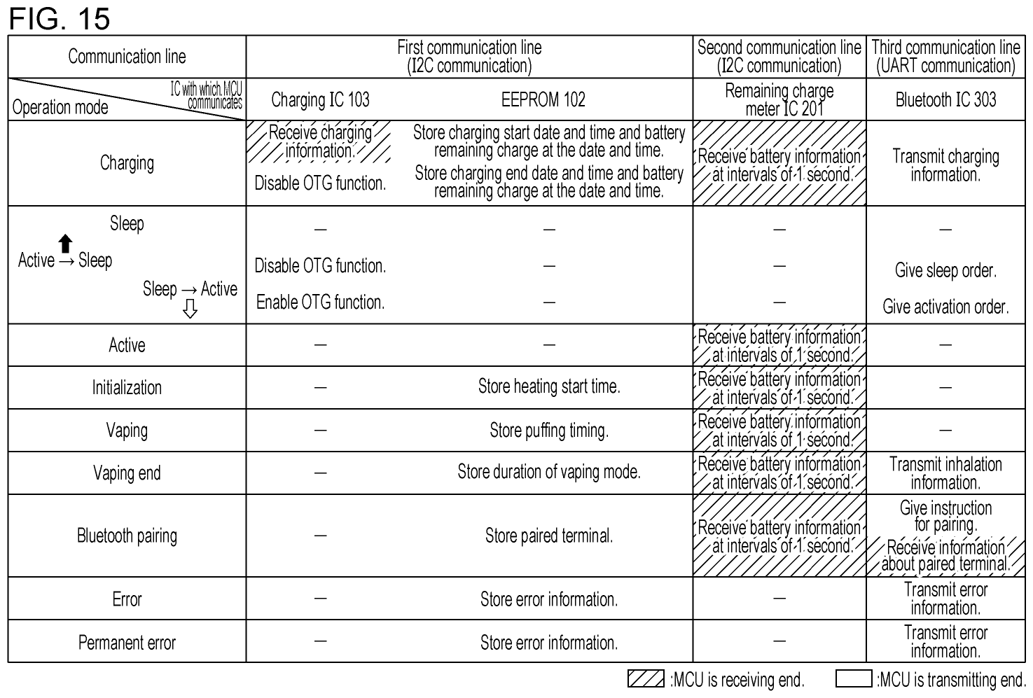

FIG. 15 is a table for explaining the details of communication on an operation-mode-by-operation-mode basis in Embodiment 2.

The aerosol generation device 1 employed in Embodiment 2 is different from that in Embodiment 1 in that communication with the remaining charge meter IC 201 through the second communication line is not performed in the error mode M3 and in the permanent error mode M4.

### Embodiment 3

The aerosol generation device 1 (see FIG. 1A) employed in Embodiment 3 is different in that part of communication in some operation modes is different from Embodiment 1.

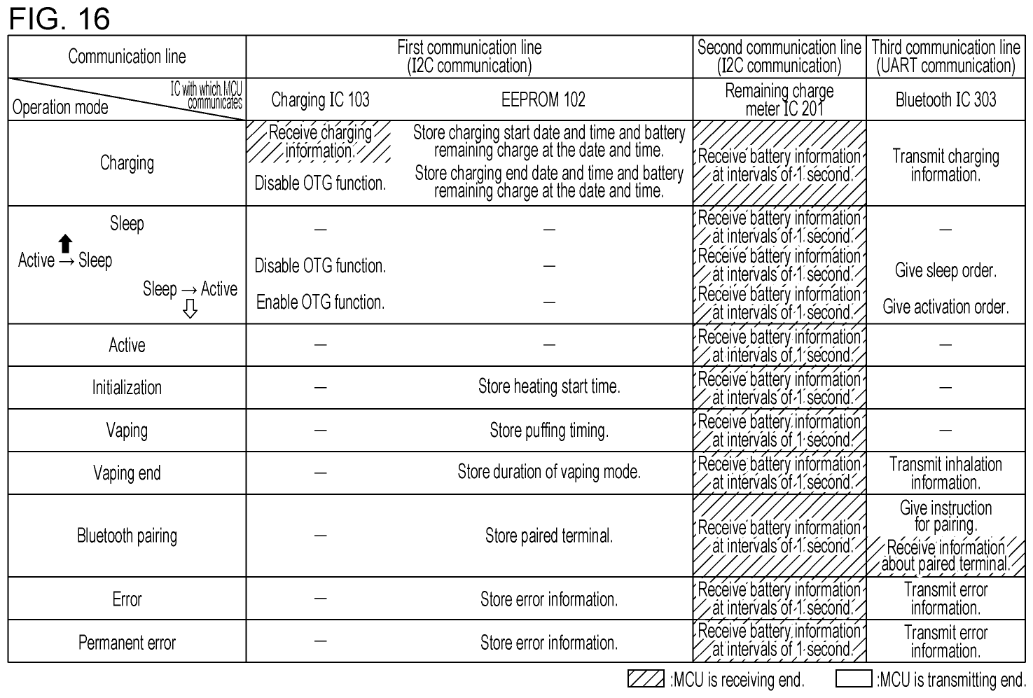

FIG. 16 is a table for explaining the details of communication on an operation-mode-by-operation-mode basis in Embodiment 3.

The aerosol generation device 1 employed in Embodiment 3 is different from that in Embodiment 1 in that communication with the remaining charge meter IC 201 through the second communication line is performed in all operation modes including the sleep mode M2.

### Other Embodiments

(1) Although embodiments of the present disclosure have been described above, the technical scope of the present disclosure is not limited to the scope described in the embodiments described above. It is obvious from the description in the claims that the above-described embodiments to which various changes or modifications are made are also fall within the technical scope of the present disclosure.

(2) Although I2C communication is employed as the communication protocol for the first communication line and the second communication line in the above-described embodiments, SPI (Serial Peripheral Interface) communication may be employed in one or both of the communication lines.

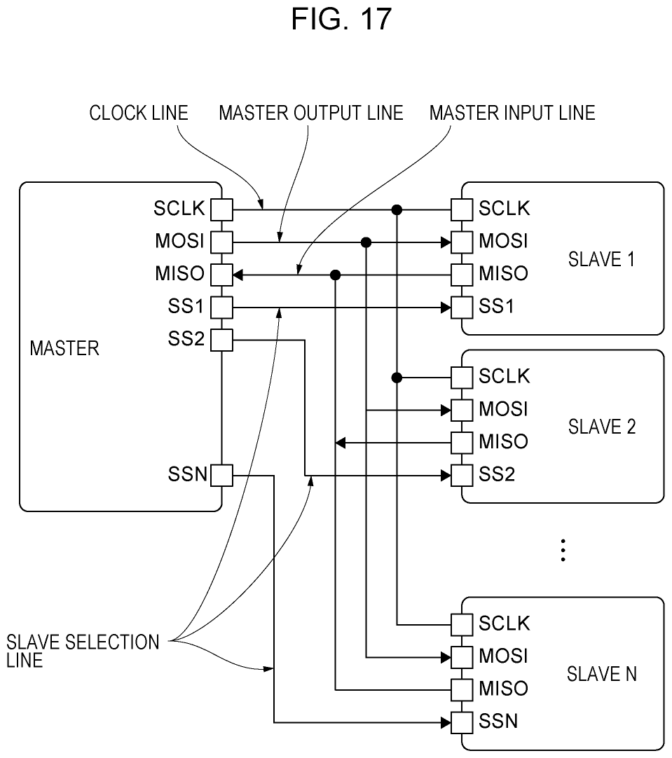

FIG. 17 is a diagram for explaining a connection form of SPI communication, which is one form of serial communication. In SPI communication, signal lines including a clock line, a master output line, a master input line, and a number of slave selection lines equivalent to the number of slaves are necessary. For example, when the number of slaves is one, the number of signal lines is four, and when the number of slaves is three, the number of signal lines is six.

SPI communication enables communication at a rate of 1 to several Mbps but is unsuitable for long-distance communication. Accordingly, SPI communication can be employed as a substitute for I2C communication.

(3) Although the MCU 101 communicates with two ICs on the same substrate in the above-described embodiments, the MCU 101 may communicate with only one IC or may communicate with three or more ICs.

Although the MCU 101 communicates with one IC on the USB connector substrate 200, the MCU 101 may communicate with a plurality of ICs on the USB connector substrate 200. The same applies to communication with the LED and Bluetooth substrate 300.

(4) Although the USB connector substrate 200 is a sole substrate that employs I2C communication in communication with the MCU 101 in the above-described embodiments, I2C communication may be employed in communication with a plurality of other substrates as long as the distances of communication with the MCU substrate 100 are short.

(5) Although a heated tobacco is assumed to be the aerosol generation device 1 in the above-described embodiments, the configuration of the circuit unit 1000 described above may be applied to electronic cigarettes.

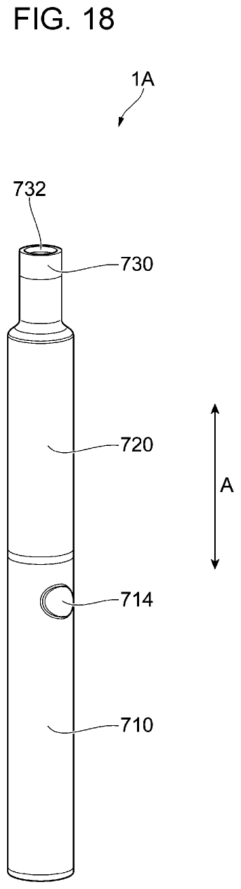

FIG. 18 is a diagram for explaining an external appearance configuration example of an aerosol generation device 1A that corresponds to an electronic cigarette.

The aerosol generation device 1A is an instrument for generating an aerosol to which flavor is imparted without burning and has a rod shape that extends in the longitudinal direction A. The aerosol generation device 1A is formed of a power supply unit 710, a first cartridge 720, and a second cartridge 730 that are disposed in the longitudinal direction A.

The first cartridge 720 is detachable from the power supply unit 710. The second cartridge 730 is detachable from the first cartridge 720.

In other words, each of the first cartridge 720 and the second cartridge 730 is replaceable.

The power supply unit 710 corresponds to the outer case 20B (see FIG. 1D) in Embodiment 1 and includes an MCU and other circuits in addition to a battery. In other words, the power supply unit 710 includes a circuit equivalent to the circuit unit 1000. On the side surface of the power supply unit 710, a button 714 is provided. The button 714 corresponds to the push button 23 (see FIG. 1D).

The first cartridge 720 includes a tank that stores a liquid that is an aerosol source, a wick that draws the liquid from the tank by a capillary action, and a coil that heats and vaporizes the liquid held in the wick.

The first cartridge 720 is also called an atomizer. In addition, the first cartridge 720 includes a flavor unit that imparts flavor to an aerosol.

The second cartridge 730 is provided with an inhalation port 732.

Note that the external appearance of the aerosol generation device 1A illustrated in FIG. 18 is an example.

(6) Although an aerosol generation device of a type in which an aerosol source is heated has been described in the above-described embodiments, the embodiments are applicable to a nebulizer that generates an aerosol by using, for example, ultrasonic waves. In this case, an ultrasonic vibrator is used instead of the heater. In this case, the MCU is configured so as to be able to control vibrations of the ultrasonic vibrator.

(7) Although an aerosol generation device has been described as an example in the above-described embodiments, the configuration of the circuit unit described above is also applicable to a portable electronic device having no aerosol generating mechanism. Specifically, the configuration of the circuit unit described above is applicable to a portable electronic device including a plurality of ICs.

### Reference Signs List

1, 1A . . . aerosol generation device, 10 . . . outer panel, 10A . . . information window, 20 . . . main-unit housing, 20A . . . inner panel, 20B . . . outer case, 22 . . . insertion hole, 22A . . . container, 24 . . . translucent component, 30 . . . shutter, 40 . . . heating unit, 50 . . . battery, 60 . . . vibrator, 100 . . . MCU substrate, 101 . . . MCU, 102 . . . EEPROM, 103 . . . charging IC, 104, 106, 109 . . . load switch, 200 . . . USB connector substrate, 201 . . . remaining charge meter IC, 300 . . . LED and Bluetooth substrate, 303 . . . Bluetooth IC, 400 . . . Hall IC substrate, 500 . . . chassis, 600 . . . flexible substrate, 710 . . . power supply unit, 720 . . . first cartridge, 730 . . . second cartridge, 1000 . . . circuit unit

1. A circuit unit for an aerosol generation device, the circuit unit comprising:
a heater connector to which a heater that heats an aerosol source by consuming electric power supplied from a power supply is connected;
a controller that includes a first communication terminal and a second communication terminal for serial communication and that controls supply of the electric power from the power supply to the heater;
a first IC that is separate from the controller and that includes a third communication terminal for serial communication;
a second IC that is separate from the controller and the first IC and that includes a fourth communication terminal for serial communication;
a first communication line that connects the first communication terminal and the third communication terminal; and
a second communication line that connects the second communication terminal and the fourth communication terminal and that does not have an electrical contact with the first communication line.

2. The circuit unit for an aerosol generation device according to claim 1, wherein
the controller receives data from the first IC at a timing that overlaps a timing when the controller receives data from the second IC or a timing when the controller transmits data to the second IC, and/or
the controller receives data from the second IC at a timing that overlaps a timing when the controller receives data from the first IC or a timing when the controller transmits data to the first IC.

3. The circuit unit for an aerosol generation device according to claim 1, wherein
the controller operates in any one of a plurality of modes, and
any one of modes, among the plurality of modes, in which the controller communicates with the first IC is the same as
any one of modes, among the plurality of modes, in which the controller communicates with the second IC.

4. The circuit unit for an aerosol generation device according to claim 1, wherein
the controller periodically communicates with the second IC.

5. The circuit unit for an aerosol generation device according to claim 1, wherein
the number of modes, among a plurality of modes, in which the controller communicates with the second IC is larger than the number of modes, among the plurality of modes, in which the controller does not communicate with the second IC.

6. The circuit unit for an aerosol generation device according to claim 5, wherein
the plurality of modes include a sleep mode in which a transition to any other mode is allowed, the sleep mode being a mode in which power consumption is smaller than in any other mode, and
the controller communicates with the second IC through the second communication line in all modes among the plurality of modes except the sleep mode.

7. The circuit unit for an aerosol generation device according to claim 5, wherein
the plurality of modes include a sleep mode in which a transition to any other mode is allowed and an error mode in which charging of the power supply is at least temporarily prohibited, the sleep mode being a mode in which power consumption is smaller than in any other mode, and
the controller communicates with the second IC through the second communication line in all modes among the plurality of modes except the sleep mode and the error mode.

8. The circuit unit for an aerosol generation device according to claim 5, wherein
the controller communicates with the second IC in all modes included in the plurality of modes.

9. The circuit unit for an aerosol generation device according to claim 1, further comprising:
a third IC that is separate from all of the controller, the first IC, and the second IC and that includes a fifth communication terminal for serial communication, wherein
the first communication line connects the first communication terminal and the fifth communication terminal.

10. The circuit unit for an aerosol generation device according to claim 9, wherein
the controller
communicates with the first IC in response to satisfaction of a first condition, and
communicates with the third IC in response to satisfaction of a second condition different from the first condition.

11. The circuit unit for an aerosol generation device according to claim 9, wherein
the controller is configured to operate in any one of a plurality of modes, and
the plurality of modes include a mode in which the controller communicates only with the third IC among the first IC and the third IC.

12. The circuit unit for an aerosol generation device according to claim 1, wherein
the number of ICs connected to the controller via the first communication line is larger than the number of ICs connected to the controller via the second communication line.

13. The circuit unit for an aerosol generation device according to claim 12, wherein
the second IC is a sole IC connected to the controller via the second communication line.

14. The circuit unit for an aerosol generation device according to claim 13, wherein
the second IC is a remaining charge meter IC that obtains information about the power supply.

15. The circuit unit for an aerosol generation device according to claim 1, wherein
the controller operates in any one of a plurality of modes, and
the plurality of modes include a mode in which the controller does not communicate with the first IC through the first communication line and does not communicate with the second IC through the second communication line.

16. The circuit unit for an aerosol generation device according to claim 1, wherein
the first communication line and the second communication line employ I2C as a communication protocol.

17. An aerosol generation device comprising:
a heater connector to which a heater that heats an aerosol source by consuming electric power supplied from a power supply is connected;
a controller that includes a first communication terminal and a second communication terminal for serial communication and that controls supply of the electric power from the power supply to the heater;
a first IC that is separate from the controller and that includes a third communication terminal for serial communication;
a second IC that is separate from the controller and the first IC and that includes a fourth communication terminal for serial communication;
a first communication line that connects the first communication terminal and the third communication terminal; and
a second communication line that connects the second communication terminal and the fourth communication terminal and that does not have an electrical contact with the first communication line.
